(19) United States
(12) Patent Application Publication
(10) Pub. No.: US 2005/0067579 A1
(43) Pub. Date: Mar. 31, 2005

(54) Nuclear medicine imaging apparatus

(76) Inventors: Katsutoshi Tsuchiya, Hitachi (JP); Hiroshi Kitaguchi, Naka (JP); Kensuke Amemiya, Hitachinaka (JP); Yuuichirou Ueno, Hitachi (JP); Norihito Yanagita, Hitachi (JP); Shinichi Kojima, Hitachi (JP); Kazuma Yokoi, Hitachi (JP); Takafumi Ishitsu, Hitachi (JP)

Correspondence Address: DICKSTEIN SHAPIRO MORIN & OSHINSKY LLP, 2101 L Street, NW, Washington, DC, 20037, US

(21) Appl. No.: 10/951,675

(22) Filed: Sep. 29, 2004

(30) Foreign Application Priority Data
Sep. 30, 2003 (JP) 2003-342679

(51) Int. Cl. G01T 1/24

(52) U.S. Cl. 250/370.15

(57) ABSTRACT

Semiconductor radiation detectors are cooled to improve accuracy in radiation detection. Semiconductor radiation detectors are cooled by heat conductance through heat conductive boards. In addition, the semiconductor radiation detectors are cooled by cooling medium filled or supplied to a heat insulating body covering the semiconductor radiation detectors.

### CROSS-REFERENCE TO RELATED APPLICATION

The present application is related to a U.S. Ser. No. ______ being filed based on Japanese Patent Application No. 2003-340688 filed on Sep. 30, 2003, the entire content of which is incorporated herein by reference, and to a U.S. Ser. No. 10/874,359 being filed based on Japanese Patent Application No. 2003-342437 filed on Sep. 30, 2003, the entire content of which is incorporated herein by reference.

### BACKGROUND OF THE INVENTION

The present invention relates to a nuclear medicine imaging apparatus and particularly relates to radiological imaging systems including nuclear medicine imaging apparatus such as Positron Emission Tomography apparatus (hereinafter referred to as PET apparatus) and Single Photon Emission Computed Tomograhy (herein after referred to as SPECT apparatus) using semiconductor radiation detector. Conventionally, as a radiation detector for detecting radiations such as γ ray, those with NaI scintillators are known. In a gamma camera (a kind of nuclear medicine imaging apparatus) comprising an NaI scintillator, radiations (gamma ray) is incident onto the scintillator with an angle controlled by a great number of collimators to cause interaction with NaI crystal to emit scintillation light. This light reaches a photomultiplier tube via a light guide to be transformed into an electric signal. The electric signal undergoes shaping with a measuring circuit mounted on a measuring circuit fixing board so as to be transmitted to an outside data collection system from an output connector. Incidentally, these scintillator, light guide, photomultiplier tube, measuring circuit, measuring circuit fixing board and the like are housed in their entirety in a light shielding housing so as to shield outside electromagnetic waves other than radiations.

Generally, a gamma camera comprising a scintillator has spatial resolution remaining around a level of several millimeters to ten several millimeters due to the structure that a large photomultiplier tube (also called as photomal) is displaced behind a large sheet of crystal such as NaI. In addition, a scintillator proceeds with detection subject to a multiple step conversion from radiation to visible light and from visible light to electron and has a problem that energy resolution is poor. Therefore, the S/N ratio on signals representing information on a real position emitting gamma ray decreases due to commingled scattered light and the like, giving rise to deterioration of images or an increase in time for imaging, which is pointed out as a problem. By comparison, as for PET apparatus (Positron Emission Tomography imaging apparatus), some provide position resolution of 5 to 6 mm and around 4 mm in case of a high end PET apparatuses, likewise suffering from a problem due to S/N ratio.

As a radiation detector for detecting radiation on a principle different from that of such a scintillator, there is a semiconductor radiation detector comprising semiconductor radiation detecting elements with semiconductor material such as CdTe (cadmium telluride), TlBr (thallium bromide), and GaAs (gallium arsenide).

Since a semiconductor radiation detecting element converts electric charge generated by interaction between radiation and semiconductor material, this semiconductor radiation detector provides better conversion efficiency to electric signals than a scintillator and excellency at energy resolution, and is, therefore, receiving attraction.
[Patent Document 1] JP-A-2000-241555 (paragraph No. 0019, FIG. 1))
[Patent Document 2] JP-A-1995-50428 (Page 2, FIG. 3)

Excellency at energy resolution means improvement of S/N ratio of radiation detecting signal providing real position information, that is, various effects such as improvement of accuracy in detection, improvement of image contrast, shortening of imaging time and the like are expectable.

A semiconductor radiation detector is used under high temperature environments due to dense placement of a plurality of semiconductor radiation detectors and integration of signal processing apparatuses to process output signals of the semiconductor radiation detector, etc. Energy resolution of a semiconductor radiation detector is deteriorated due to increase of leak currents by increase in temperature.

The purpose of the present invention is to provide a radiological imaging system that can improve image contrast and is compact.

### SUMMARY OF THE INVENTION

The present invention includes a housing member, a plurality of semiconductor radiation detectors disposed in the housing member, and an integrated circuit for processing radiation detection signals that the plurality of semiconductor radiation detectors output respectively, and comprises a plurality of detector unit attached to a support member in a detachable/attachable manner, and a cooling apparatus to cool the semiconductor radiation detector is provided to each of the aforementioned detector unit.

The present invention provides a cooling apparatus to every detector unit, and therefore, can miniaturize the respective cooling apparatus and can make a nuclear medicine imaging apparatus compact. Provision of a cooling apparatus to every detector unit improves cooling efficiency of a semiconductor radiation detector.

Cooling a semiconductor radiation detector provided to a nuclear medicine imaging apparatus, reduction of noise (decrease in leak current), improvement in mobility of generated charge and increased life of generated charge can be pursued, and accuracy in radiation detection can be improved. Such improvement of accuracy in radiation detection can improve contrast on an obtained image. Thus, accuracy in examination on position of abnormality (for example, malignant tumor) of an examinee can be improved. Incidentally, with image quality at a level approximately similar to a conventional one, practical improvement of sensitivity will shorten the imaging time.

Preferably, the cooling apparatus is configured to form a flow of cooling medium in the housing, and in the housing, integrated circuits are disposed at a downstream side further than the plurality of radiation detectors in the direction of flow of the cooling medium. Since the cooling medium is brought into contact with semiconductor radiation detector prior to the integrated circuits with larger heat generation, cooling efficiency of the semiconductor radiation detector increases. In addition, the integrated circuits can be cooled with the cooling medium after cooling the semiconductor radiation detector.

Preferably, it is desirable that a cooling apparatus is attached to the board member included in the unit board. The semiconductor radiation detector is cooled with the cooling apparatus via the board member. The board member includes heat conductive member so that cooling efficiency of the semiconductor radiation detector increases further.

The aforementioned cooling apparatus is provided in the aforementioned board member so as to cool the aforementioned semiconductor radiation detector via the aforementioned board member.

Preferably, it is advisable that another cooling apparatus to cool the integrated circuits is provided in the housing member.

Preferably, it is advisable that a sealing member to cover a plurality of radiation detectors is provided in the unit board and the cooling apparatus is provided in the space surrounded by the sealing member to supply the cooling medium. Since the cooling medium is supplied to narrower space in the sealed member, cooling efficiency of the semiconductor radiation detector is improved further.

According to the present invention, improvement in accuracy in radiation detection can be planned since a semiconductor radiation detector can be cooled. This improves, for example, image contrast in a radiological imaging system so that clear image is obtainable.

In addition, respective cooling apparatus can be made smaller in size and a radiological imaging system can be made compact.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view of a configuration of a PET apparatus as a nuclear medicine imaging apparatus related to the present invention;

FIG. 2 is a schematic view of a section of a camera of the PET apparatus in FIG. 1 in the circumferential direction;

FIG. 3 is a schematic view of a structure of minimum configuration of a semiconductor radiation detector;

FIG. 4 is a schematic view of a configuration of a semiconductor radiation detector having a lamination structure with a semiconductor material and electrodes (anode and cathode) being laminated;

FIG. 5 is a perspective view of a configuration of a detector unit related to Embodiment 1;

FIG. 6A is a front view of a combined board of a detector unit of FIG. 5;

FIG. 6B is a side view of FIG. 6A;

FIG. 6C is a perspective view of a configuration of a semiconductor radiation detector mounted on a detector board of FIG. 6A hereof in a perspective manner;

FIG. 7 is a sectional schematic view of the detector unit of FIG. 5;

FIG. 8 is a schematic view of a configuration of another cooling mechanism in the detector unit;

FIG. 9 is a side view of the detector unit of FIG. 8;

FIG. 10 is a perspective view of a configuration of another cooling mechanism in the detector unit;

FIG. 11A is a front view of the detector unit of the semiconductor detector of FIG. 10;

FIG. 11B is a side view of FIG. 11A hereof;

FIG. 12 is a sectional schematic view of the detector unit of FIG. 10;

FIG. 13 is a perspective view of a configuration of a SPECT apparatus as nuclear medicine imaging apparatus related to the present invention;

FIG. 14 is a schematic view of a configuration of a combined board with a detector board and ASIC boards of a semiconductor radiation detector in Embodiment 2 brought into integration;

FIG. 15 is a perspective view describing a cooling mechanism of a detector unit related to Embodiment 2 in a schematic manner;

FIG. 16 is a schematic view of the detector unit of FIG. 15 partially enlarged;

FIG. 17 is a perspective view describing another cooling mechanism in Embodiment 2;

FIG. 18 is a block diagram of an analog ASIC circuit shown in FIG. 6 in a schematic manner;

FIG. 19 is a block diagram of a schematic configuration of a digital ASIC shown in FIG. 6 and a connection relationship of analog ASIC and a digital ASIC;

FIG. 20A is a partially cutaway view of a camera showing appearance when a detector unit shown in FIG. 5 is attached to the camera;

FIG. 20B is a sectional view of a central part of the camera; and

FIG. 21 is a block diagram of schematic configuration of a digital ASIC in the SPECT apparatus of FIG. 13 and of a connection relationship of the analog ASIC and the digital ASIC.

### DESCRIPTION OF THE EMBODIMENTS

The following will specifically describe a nuclear medicine imaging apparatus according to a preferred embodiment 1 and embodiment 2 of the present invention with appropriate reference to the accompanying drawings. Incidentally, the following will describe a nuclear medicine imaging apparatus 1 of Embodiment 1 as well as Embodiment 2 and will describe a semiconductor radiation detector, integrated circuits and the like. Incidentally, an analog ASIC is a kind of LSI, meaning an ASIC (Application Specific Integrated Circuit) being an IC for specific purposes to process analog signals.

[Embodiment 1]

Nuclear Medicine Imaging Apparatus

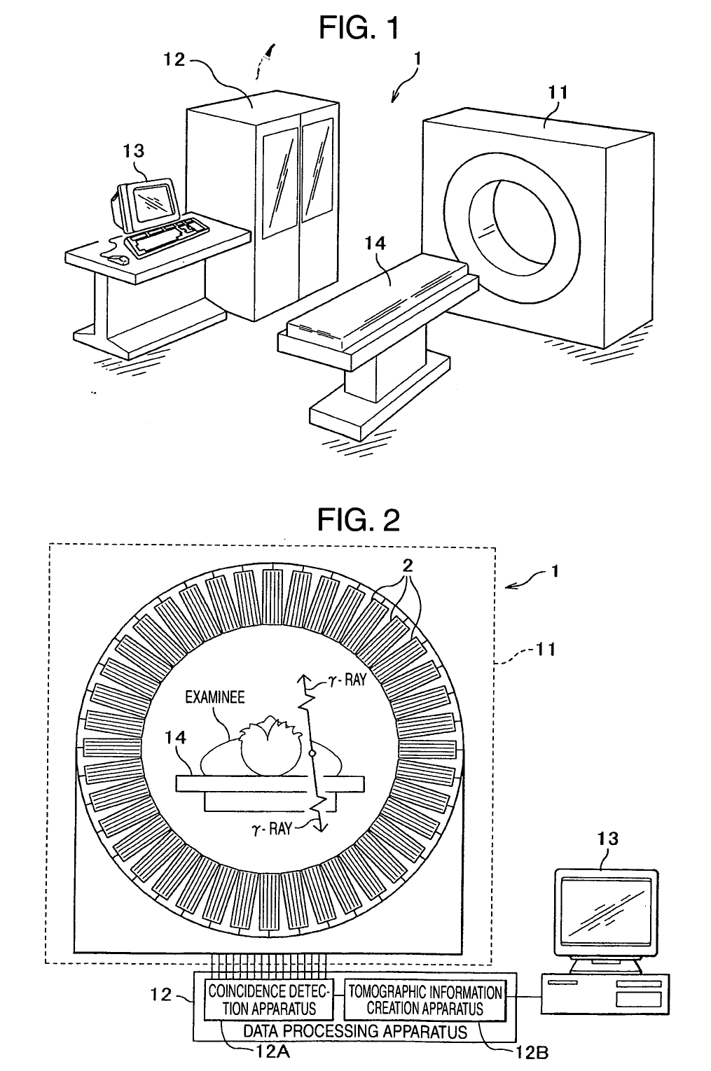

At first, the nuclear medicine imaging apparatus (radiological imaging apparatus) of Embodiment 1 will be described. As shown in FIG. 1, a PET apparatus 1 as a nuclear medicine imaging apparatus is configured to comprise a camera (imaging apparatus) 11, a data processing apparatus 12 and a display apparatus 13. An examinee (subject) is loaded on the bed 14 so as to be imaged by the camera 11. The camera 11 has a great number of built-in semiconductor radiation detectors 21 so as to detect gamma rays emitted out of the body of an examinee with the semiconductor radiation detectors 21 (hereinafter referred to simply as detector) 21. The camera 11 comprises an integrated circuit (ASIC) that the peak value i.e. energy and detection time of the detected radiation (γ-ray) are measured. The data processing apparatus 12 has a storage apparatus, a coincidence detection apparatus 12A (to be referred to in FIG. 2), and a tomographic information creation apparatus 12B (to be referred to in FIG. 2). The data processing section apparatus 12 captures packet data including energy of detected γ-rays, data of detection time, and detector (channel) IDs. The coincidence detection apparatus 12A performs coincidence detection based on the packet data, particularly the data of detection time and the detector IDs, identifies the detection positions of 511 keV γ-rays, and stores the positions in the storage apparatus.

The tomographic information creation apparatus 12B creates a functional image based on the identified positions to be displayed in the display apparatus 13.

As shown in FIG. 2, in the interior of the camera 11, detector units 2 storing a plurality of combined boards 20 each of which has a great number of detectors 21 are arranged like a circle in order to detect a γ-ray radiated from the examinee. The examinee lies on the bed 14 so as to be positioned at the center of the camera 11. At this point, the respective detectors surround the bed 14. From the detector units 2, γ-ray energy information and γ-ray detection time information that are obtained based on a detection signal when the detectors 21 interact with γ-rays, and the address information (detector ID) of the detector 21 are outputted for each of the detectors 21 included in the detector unit 2. The configurations of the detector 21, the combined board 20, and the detector unit 2 will be specifically described later.

Incidentally, radioactive chemicals, e.g. fluorodeoxyglucose (FDG) containing 18F having a half-life of 110 minutes are administered to the examinee. From the body of the examinee H, γ-rays (annihilation γ-rays) are radiated when positrons emitted from the FDG are annihilated.

The characteristic parts of the present Embodiment will be described below.

Semiconductor Radiation Detector

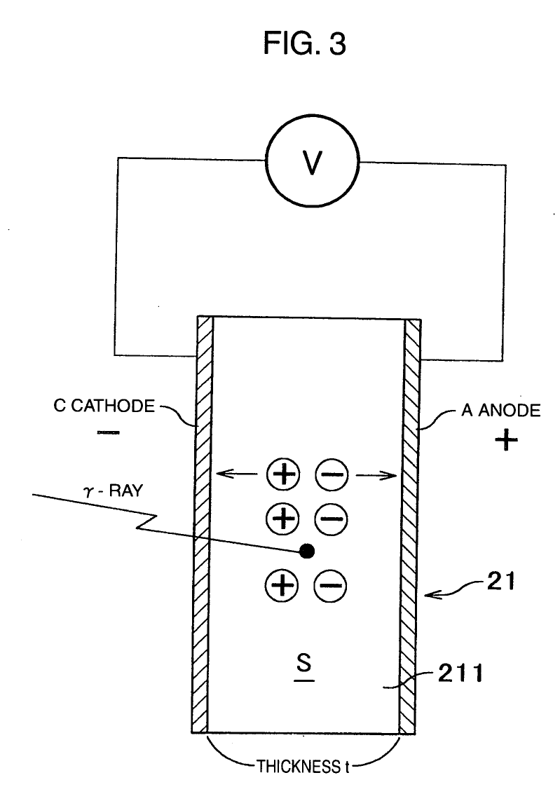

As shown in FIG. 3, the detector 21 is configured (minimum configuration) so that both sides of a semiconductor radiation detection element (hereinafter, referred to as a detection element) 211 composed of a plate-like semiconductor material S are covered with electrodes (anode A, cathode C) shaped like thin plates (films). In this configuration, the semiconductor material S is composed of any one of single crystals including CdTe (cadmium telluride), TlBr (thallium bromide), and GaAs (gallium arsenide). Further, the electrodes (anode A, cathode C) are made of any one of materials including Pt (platinum), Au (gold), and In (indium). In the following explanation, the semiconductor material S composed of a single crystal of CdTe is sliced. Moreover, a detecting radiation is a γ-ray of 511 KeV that is used in the PET apparatus.

The detection principle of a γ-ray in the detector 21 will be schematically described with reference to FIG. 3. When a γ-ray is incident on the detector 21 and the γ-ray and the semiconductor material S constituting the detector 21 interact with each other, holes and electrons (schematically indicated as “+” and “−” in the drawing) are generated in pairs up to an amount in proportion to the energy of the γ-ray. In this configuration, voltage for collecting charge is applied across the electrodes of the anode A and the cathode C of the detector 21 (e.g., 300V). Thus, the holes are attracted to the cathode C and the electrons are attracted to the anode A.

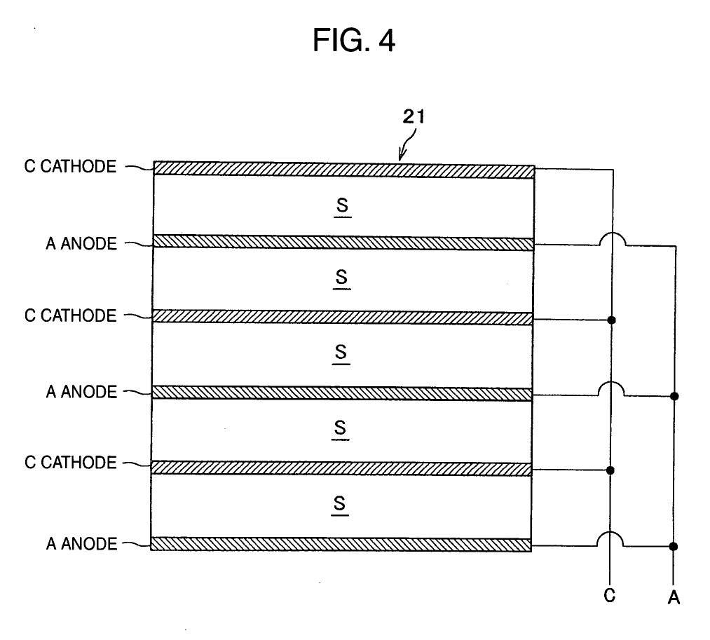

As shown in FIG. 4, the detector 21 has the semiconductor material S laminated into five layers each of which is disposed between the cathode C and the anode A (detector element 211). In addition, the detector 21 is a single-layer detector in which each layer of the semiconductor material S has the thickness t (0.2 to 2 mm (more preferably 0.5 to 1.5 mm)). The anode A and the cathode C respectively are about 20 microns in thickness. Incidentally, in the detector 21 having the laminated structure shown in this FIG. 4, since the anodes A are connected to one another and the cathodes C are connected to one another, each layer does not detect a radiation separately from the other layers. In other words, in configuration, when a γ-ray and the semiconductor material S interact with each other, it is not decided whether the interaction occurs in the top layer or the bottom layer. As a matter of course, detection may be configured to be carried out in each layer. Incidentally, the five-layer structure is constructed for the following reason: When the thickness t of the semiconductor material S is small, a peak value increases quickly to a higher value but more γ-rays pass through the material in the smaller thickness, whereas the five-layer structure can reduce the number of γ-rays passing through the material to increase interactions between the semiconductor material S and the γ-rays (to increase the number of counts) while increasing the efficiency of collecting charge.

With the detector 21 having such a laminated structure, it is possible to obtain a more preferable increase rate (rise) in peak value and a more accurate peak value, and increase the number of γ-rays (the number of counts) interacting with the semiconductor material S (increase sensitivity).

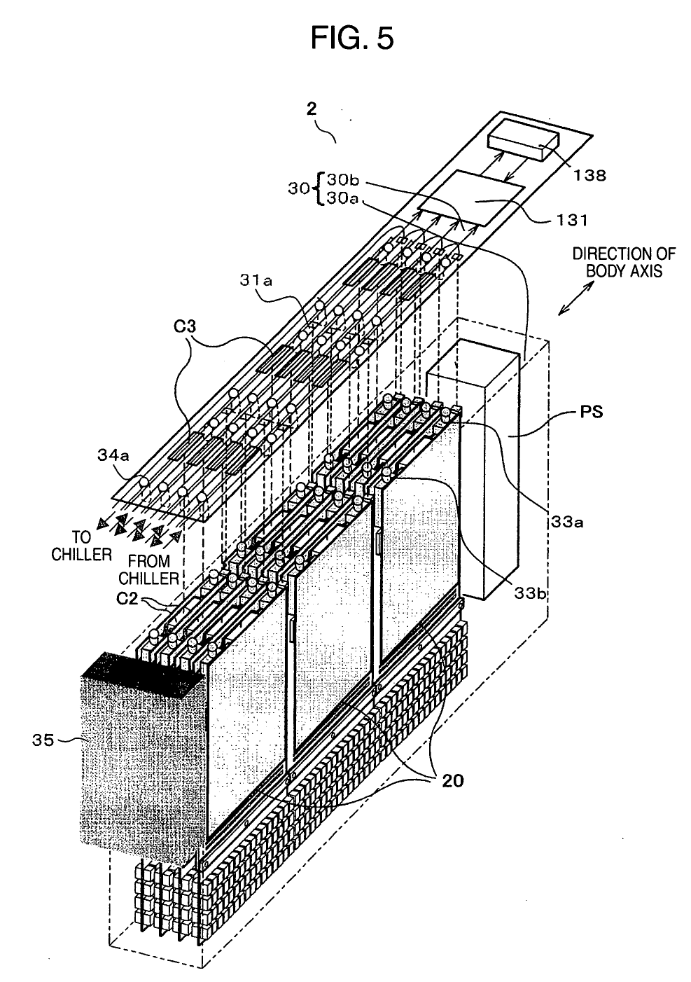

Incidentally, in the above explanation, the semiconductor material S interacting with a γ-ray was CdTe, but it is needless to say that the semiconductor material S may be TlBr and GaAs, etc. Further, although the words of “the laminated structure”, “top layer” and “bottom layer” were used, the words are used with reference to FIG. 4, and when it is seen after being rotated by 90°, “the laminated structure” may be replaced with, for example, a “parallel structure” and the “top and bottom” may be replaced with “right and left.” The direction of γ-ray incidence may be from the top, bottom, left, or right of FIG. 5. In other words, the detector 21 is configured so that the plurality of (e.g., five) semiconductor material S are arranged in parallel in such a manner as to be sandwiched between the cathode C and the anode A.

Detector Unit

Each of detection units 2 placed inside the camera 11 is configured, as shown in FIG. 5, to house 12 combined boards 20 in a heat insulating covering (frame) 30 being a housing member (12 combined boards 20). Incidentally, the camera 11 of the PET apparatus 1 is configured so that 60 to 70 detector units 2 hereof are arranged in the circumferential direction in a detachable/attachable manner (FIG. 2) so as to facilitate maintenance and examination.

Combined Board; Detector Board and ASIC Board

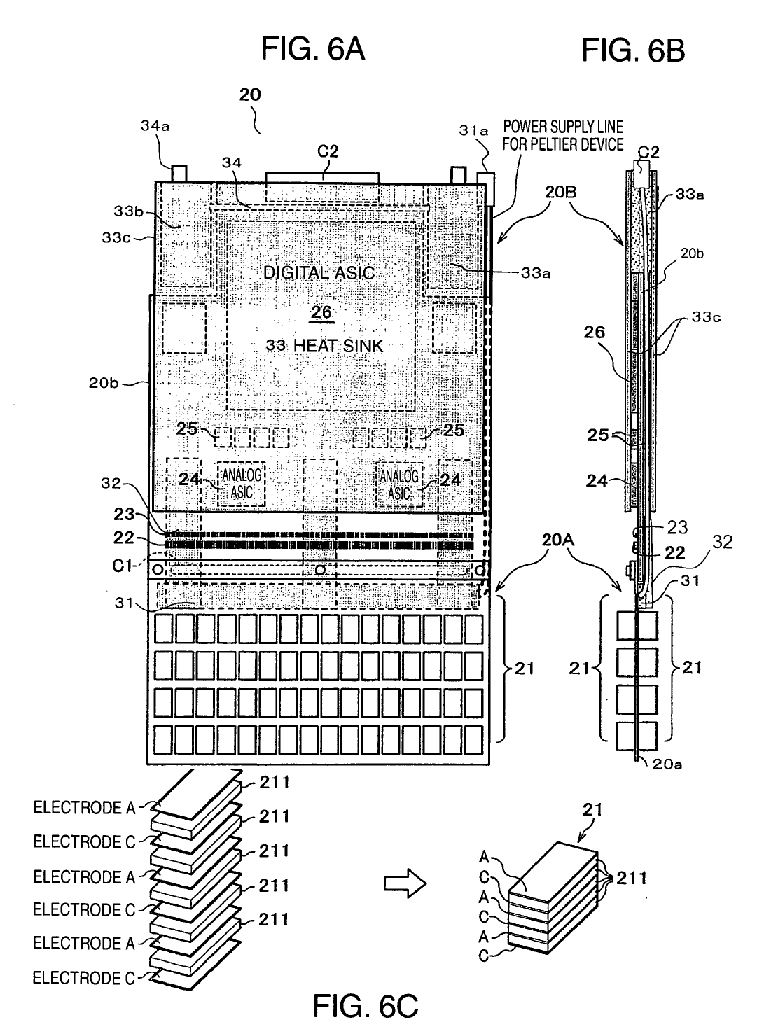

Referring to FIG. 6, the following will describe the detailed structure of the combined board (unit board) 20 mounted in the detector unit 2 (FIG. 5). The combined board (semiconductor radiation detector) 20 has a detector board (first board) 20A having the plurality of detectors 21, and an ASIC board (second board) 20B having capacitors 22, resistors 23, analog ASICs 24, analog/digital converters (hereinafter referred to as ADC) 25, and a digital ASIC 26.

Detector Board

Referring to FIGS. 6A to 6C, the detector board 20A having the detectors 21 will be described below. As shown in FIG. 6A, in the detector board 20A, the plurality of detectors 21 are arranged and mounted (packaged) in a lattice pattern on one side of the board body 20a (four lines of the 16 detectors 21, that is, 4×16=64 in total). In the radius direction of the camera 11, four lines of the detectors 21 are arranged on a board body 20a. Incidentally, the above-described 16 detectors 21 are arranged in the axial direction of the camera 11, that is, in the longitudinal direction of the bed 14. Further, as shown in FIG. 6B, the detectors 21 are attached on both sides of the detector board 20A and thus each of the detector boards 20A will have a total of 128 detectors 21. Here, as the attached detectors 21 increase in number, γ-rays can be more readily detected with higher accuracy of position. Thus, the detectors 21 are arranged on the detector board 20A as densely as possible. Incidentally, when γ-rays radiated from the examinee on the bed 14 move from below to above (the direction of an arrow 32, i.e., the radius direction of the camera 11) in FIG. 6A, it is preferable to arrange the detectors 21 densely in the lateral direction of the detector board 20A in order to reduce the number of γ-rays passing though the detectors 21 (the number of γ-rays passing through gaps between the detectors 21). Hence, it is possible to improve the efficiency of detecting γ-rays, thereby increasing the spatial resolution of an obtained image.

Incidentally, as shown in FIG. 6B, the detector board 20A of the present embodiment has the detectors 21 attached to both sides of the board body 20a, and therefore unlike a detector board having detectors only on one side, the board body 20a can be used in a shared manner by mounting the detectors 21 on both sides. Hence, it is possible to reduce the number of the board bodies 20a by half and arrange the detectors 21 more densely in the circumferential direction. In addition, as described above, the number of the detector boards 20A (combined boards 20) can be reduced by half, therefore, giving rise to an advantage that it is possible to save time and trouble to attach the combined boards 20 to a housing 30 (FIG. 5), which will be discussed later.

In the above explanation, the 16 detectors 21 across the board are arranged in the axial direction of a camera 11 in configuration, but the configuration is not particularly limited thereto. For example, the 16 detectors 21 across the board may be configured to be arranged in the circumferential direction of the camera 11.

As shown in FIG. 6C, each of the detectors 21 has a laminated structure where the single crystals of the semiconductor material S (detector element 211) are laminated like above-described thin plates. A supplementary explanation will be given below about the configuration and operation hereof, which have been discussed with reference to FIG. 6A to 6C. As described above, the detector 21 has the anodes A and the cathodes C, and a potential difference (voltage) such as 300 V is set across the anode A and the cathode C in order to collect charge. This voltage is supplied from the ASIC board 20B to the detector board 20A via a connector C1 (FIG. 6A). Further, a signal detected by the detector 21 is supplied to the ASIC board 20B via the connector C1. Hence, in the board body 20a of the detector board 20A, a not shown inner-board wiring (for collecting charge and for transmitting and receiving a signal) which connect the connector C1 and the respective detectors 21, are provided. Besides, the inner-board wiring hereof has a multilayered structure. In the present embodiment, the respective detector elements 211 of the detector 21 are arranged in parallel with the board body 20a. The detector 21 may be attached so that the respective detector elements 211 are arranged perpendicularly to the board body 20a.

(ASIC Board)

The ASIC board 20B having the ASIC will be described below. As shown in FIG. 6A, the ASIC board 20B has the two analog ASICs 24 and one digital ASIC 26 on one side of the board body 20b. In addition, as shown in FIG. 6B, since the analog ASICs 24 are attached on both sides of the board body 20b, the ASIC board 20B has a total of four analog ASICs 24. Further, the ASIC board 20B has the eight (=4×2) ADCs 25 on one side of the board body 20b and the 16 ADCs 25 on both sides thereof. Moreover, on both sides of one board body 20b, the capacitors 22 and the resistors 23 are arranged as many as the detectors 21. Like the aforementioned detector board 20A, the ASIC board 20B (board body 20b) has inner-board wiring (not shown) to electrically connect the capacitors 22, the resistors 23, the analog ASICs 24, the ADCs 25, and the digital ASIC 26. The inner-board wiring also has a laminated structure.

In the arrangement (inner-board wiring) of the respective elements 22, 23, 24, 25, and 26, a signal supplied from the detector board 20A is sent to the capacitors 22, the analog ASICs 24, the ADCs 25, and the digital ASIC 26 in this order.

Additionally, the ASIC board 20B has the connector (spiral contact) C1 which is connected to the inner-board wiring connected to the respective capacitors 22 and makes an electrical connection with the detector board 20A, and a board connector C2 which makes an electrical connection with the data processing apparatus. Incidentally, the above-described detector board 20A also has the connector C1 which is connected to the inner-board wiring connected to the detectors 21.

(Connecting Structure of the Detector Board and the ASIC Board)

The following will describe the connecting structure of the detector board 20A and the ASIC board 20B.

Instead of connecting the detector board 20A and the ASIC board 20B by butt-joining the end faces (ends), as shown in FIG. 6B, overlapping portions are provided near the ends to connect the connectors C1 attached to the overlapping portions. This connection is made in a detachable/attachable manner (is freely separated and connected) by a fastening screw and the like. Such a connection is made for the following reason. That is, when one or both ends of the combined board 20 is horizontally supported, which has the detector board 20A and the ASIC board 20B connected (joined) to each other, force distorting or bending down the combined board 20 is applied to the center (connected part) of the combined board 20. Here, in the case where the connected part has butted end faces, the connected part is readily distorted or bent, which therefore is not preferable.

In consideration of this point, in the present embodiment, instead of connecting the detector board 20A and the ASIC board 20B by butt-joining the end face, a connection is made by providing the overlapping portions where the ends overlap each other as described above. Thus, as compared with the butt-joined end faces, such a connection is preferable because a resistance to distortion and bending is improved. When the combined board increases the resistance to distortion and bending, for example, the displacement of the detector 21 is reduced so as to prevent a reduction in the accuracy of locating the occurrence of a γ-ray. Incidentally, as shown in FIG. 2, the camera 11 of the PET apparatus 1 has a great number of detector units 2 which have the combined boards 20 shown in FIGS. 6A-6C and are arranged like a donut, and thus, the combined boards 20 disposed at 3 o'clock and 9 o'clock positions in the horizontal direction of FIG. 2 are readily distorted or bent. For this reason, it is important for the combined board 20 to obtain resistance to distortion and bending.

The detector board 20A and the ASIC board 20B are electrically connected to each other by using the overlapping portions as described above. Thus, the connector C1 (FIG. 6A) for electrically connecting the inner-board wirings of the boards 20A and 20B is provided on each of the overlapping portions of the detector board 20A and the ASIC board 20B shown in FIG. 6B. For example, a spiral contact (R) is used as the connector C1 to preferably make an electrical connection. The spiral contact (R) is characterized in that a connecting terminal shaped like a ball makes contact with a spiral contact through a wide area so as to preferably make an electrical connection. When the connecting terminal shaped like a ball is provided on the ASIC board 20B, the spiral contact is provided on the detector board 20A, and when the connecting terminal shaped like a ball is provided on the detector board 20A, the spiral contact is provided on the ASIC board 20B.

Since the detector board 20A and the ASIC board 20B are electrically connected to each other in such a manner, a signal can be transmitted from the detector board 20A to the ASIC board 20B with low loss. Lower loss increases, for example, the energy resolution as the detector 21.

As described above, the detector board 20A and the ASIC board 20B are connected to each other via a screw and the like in a detachable/attachable manner. Therefore, for example, even when the semiconductor radiation detectors 21 and the ASICs 24 and 26 have defects, it is only necessary to replace defective parts. Thus, it is possible to eliminate waste of the replacement of the overall combined board 20 even in the event of a defective part. Further, the detector board 20A and the ASIC board 20B are electrically connected to each other via the connector C1 such as the above-described spiral contact (R), thereby readily brought into connection/disconnection (coupling/decoupling) the boards.

In the above configuration, one detector board 20A is connected to the ASIC board 20B, but the detector board may be divided into two or more. For example, the detectors 21 in eight columns and four rows may be configured to be packaged on one board and two detector boards be connected to the ASIC board. In this configuration, when one of the detectors 21 is failed, it is only necessary to replace the detector board having the failed detector out of the two detector boards, thereby making reduction of waste in maintenance (reducing cost) attainable.

(Layout of Elements)

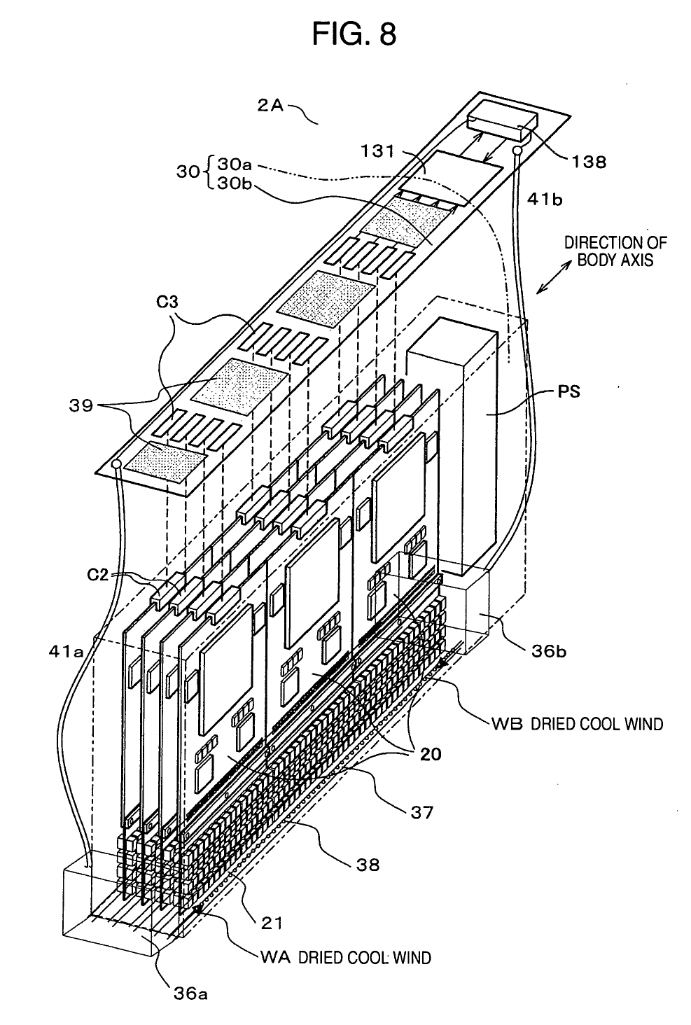

Referring to FIGS. 6A to 6C and 8, the following will describe the layout of the elements such as the detectors 21 and the ASICs 24 and 26 on the combined board 20.

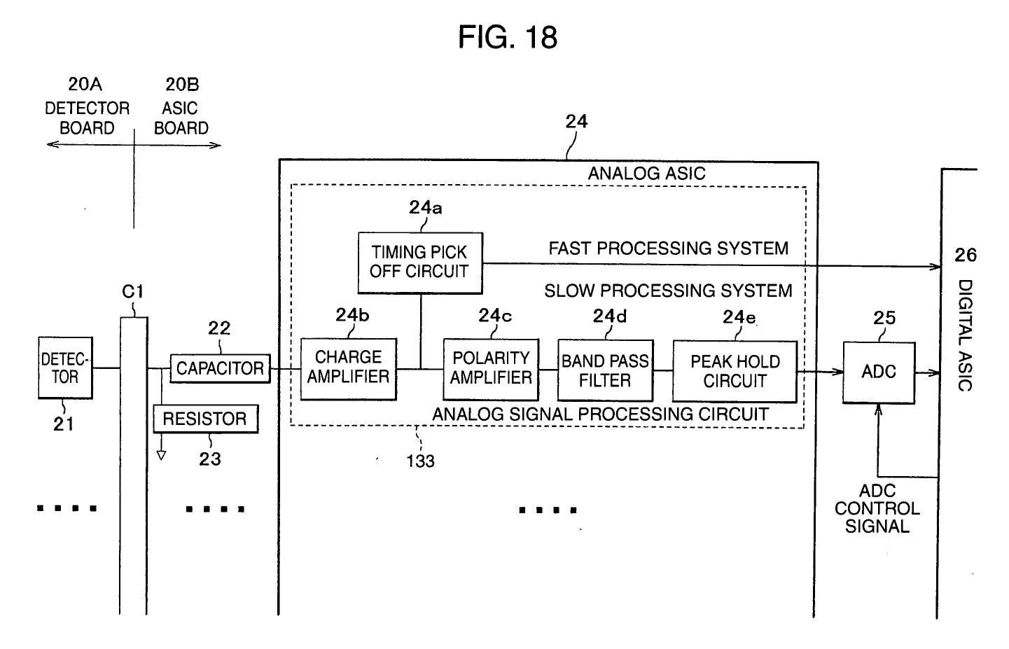

As shown in FIGS. 6A to 6C, the detector 21 is connected to the analog ASIC 24 via the connector C1 and the capacitor 22 by using electrical wiring (not shown). The resistor 23, as shown in FIG. 18, is connected to a wiring connecting the connector C1 and a capacitor 22. A detection signal of a γ-ray detected by the detector 21 is arranged to pass through the capacitor 22 via the electrical wiring and be processed in the analog ASIC 24. Further, the signal processed in the analog ASIC 24 is arranged to be processed in the ADC 25 and the digital ASIC 26.

Here, short wiring (distance) is preferable, because the influence of noise and the attenuation of a signal are reduced in the processing. Further, when a coincidence detection is conducted in the PET apparatus 1, shorter wiring are preferable because a delay is reduced (preferable because the accuracy of detection time is not reduced). Thus, in the present embodiment, the detectors 21, the capacitors 22, the resistors 23, the analog ASICs 24, the ADCs 25, and the digital ASIC 26 are arranged (laid out) in the order of the elements 21, 23, 22, 24, 25 and 26 from the axis to the outside in the radius direction of the camera 11 as shown in FIG. 6A. That is, from the axis of the camera 11 to the outside, “detectors, analog integrated circuits, AD converters, and a digital integrated circuit are arranged in this order on a board and wiring is carried out in this order.” Hence, a weak signal detected by the detector 21 can be transmitted to the analog ASIC 24 by reducing the length of the wiring (distance).

Incidentally, since processing such as the amplification of a signal is performed in the analog ASIC 24, even when wiring after the analog ASIC 24 is long, a signal is less susceptible to noise. That is, in consideration of noise, no problem occurs even if wiring after the analog ASIC 24 is long. However, as described above, long wiring delays the transmission of a signal and thus the accuracy of detection time may be reduced.

In the present embodiment, since one combined board 20 includes the analog ASICs 24 and the digital ASIC 26 as well as the detectors 21, it is possible to arrange the detectors 21, the analog ASICs 24, and the digital ASIC 26 in the orthogonal direction of the longitudinal direction of the bed 14, that is, orthogonally to the body axis of the examinee to be examined, and thus, the length of the camera (imaging apparatus) 11 in the longitudinal direction of the bed does not have to be increased more than necessary. It can be considered that the analog ASICs 24 and digital ASICs 26 are disposed along the longitudinal direction of the bed 14 on the outer side of the radius direction of the detectors arranged like a ring, but the camera 11 becomes longer than necessary in the longitudinal direction of the bed. Moreover, a semiconductor radiation detector is used as the detector 21, and the analog ASIC 24 and the digital ASIC 26 are used as signal processors, and thus, it is possible to reduce a length in the longitudinal direction of the combined board 20 and considerably reduce a length in the above-mentioned orthogonal direction of the camera 11 as compared with the case where a scintillator is used. Further, since the combined board 20 has the detectors 21, the analog ASICs 24, and the digital ASIC 26 which are arranged sequentially along the longitudinal direction of the combined board 20, the wiring for connecting the elements can be shortened and the wiring of the board can be simplified.

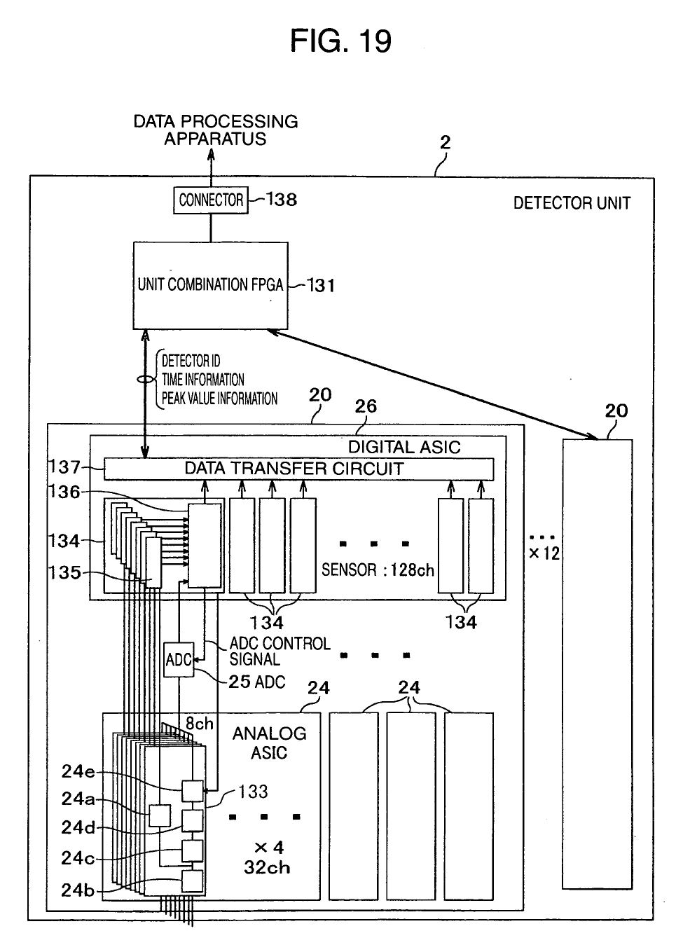

Here, in the present embodiment, one analog ASIC 24 is connected to the 32 detectors 21 to process signals obtained from the detectors 21. As shown in FIGS. 18 and 19, one analog ASIC 24 comprises 32 sets of analog signal processing circuits (analog signal processing apparatus) 133 made up of a slow processing system and fast processing system. The analog signal processing circuit 133 is provided for each of the detectors 21 and is connected to one detector 21. The fast processing system comprises a timing pick off circuit 24a to output a timing signal for identifying a detection time of γ-rays. The timing pick off circuit 24a is connected to the output end of a charge amplifier (preamplifier) 24b. The slow processing system comprises a charge amplifier 24b, a polarity amplifier (linear amplifier) 24c, a band pass filter (waveform shaping apparatus) 24d and a peak hold circuit (peak value holding apparatus) 24e connected in this order for the purpose of calculating a peak value of the γ-ray detection signals. Incidentally, the slow processing system is named “slow” because it takes a certain degree of processing time to calculate a peak value. The γ-ray detection signal outputted from the detector 21 and passed through the capacitor 22 and resistor 23 is amplified in the charge amplifier 24b and polarity amplifier 24c. The amplified γ-ray detection signal is passed through the band pass filter 24d and inputted to the peak hold circuit 24e. The peak hold circuit 24e holds a maximum value of the detection signal, that is, the peak value of a γ-ray detection signal proportional to energy of the detected γ-rays. One analog ASIC 24 is an LSI which integrates 32 sets of analog signal processing circuits 33.

The capacitor 22 and resistor 23 can also be provided inside the analog ASIC 24, but the present embodiment arranges the capacitor 22 and resistor 23 outside the analog ASIC 24 for reasons such as obtaining an appropriate capacitance and appropriate resistance and reducing the size of the analog ASIC 24. The capacitor 22 and resistor 23 are preferably disposed outside because variations in the individual capacitance and resistance are reduced.

In the analog ASIC 24 shown in FIG. 18, the output of the slow processing system of this analog ASIC 24 is arranged to be supplied to the ADC (analog/digital converter) 25 in the present embodiment. Moreover, the output of the fast processing system of the analog ASIC 24 is designed to be supplied to the digital ASIC 26.

The analog ASIC 24 and each ADC 25 are connected via one wire which sends slow processing system signals corresponding to 8 channels all together. Furthermore, each analog ASIC 24 and digital ASIC 26 are connected via 32 wires which send 32-channel fast processing system signals one by one. That is, one digital ASIC 26 is connected to four analog ASICs 24 via a total of 128 wires.

The output signal of the slow processing system outputted from the analog ASIC 24 is an analog peak value. Further, the output signal of the fast processing system outputted from the analog ASIC 24 to the digital ASIC is a timing signal indicating timing corresponding to the detection time. Of these signals the peak value which is the slow processing system output is inputted to the ADC 25 via the wire connecting the analog ASIC 24 and ADC 25, and is converted to a digital signal by the ADC 25. The ADC 25 converts a peak value to, for example, an 8-bit (O to 255) digital peak value (e.g., 511 KeV→255) and, moreover, a timing signal serving as the output of the slow processing system is supplied to the digital ASIC 26 via the wire connecting the aforementioned analog ASIC 24 and digital ASIC 26.

The ADC 25 sends the digitalized 8-bit peak value information to the digital ASIC 26. ADC 25 and digital ASIC 26 thus are connected via a wire. For example, since there are 16 ADCs 25 on both sides, the digital ASIC 26 is connected to the ADC 25 via a total of 16 wires. One ADC 25 processes signals corresponding to 8 channels (signals corresponding to eight detection elements). Incidentally, the ADC 25 is connected to the digital ASIC 26 via a wire for transmitting an ADC control signal and a wire for transmitting peak value information.

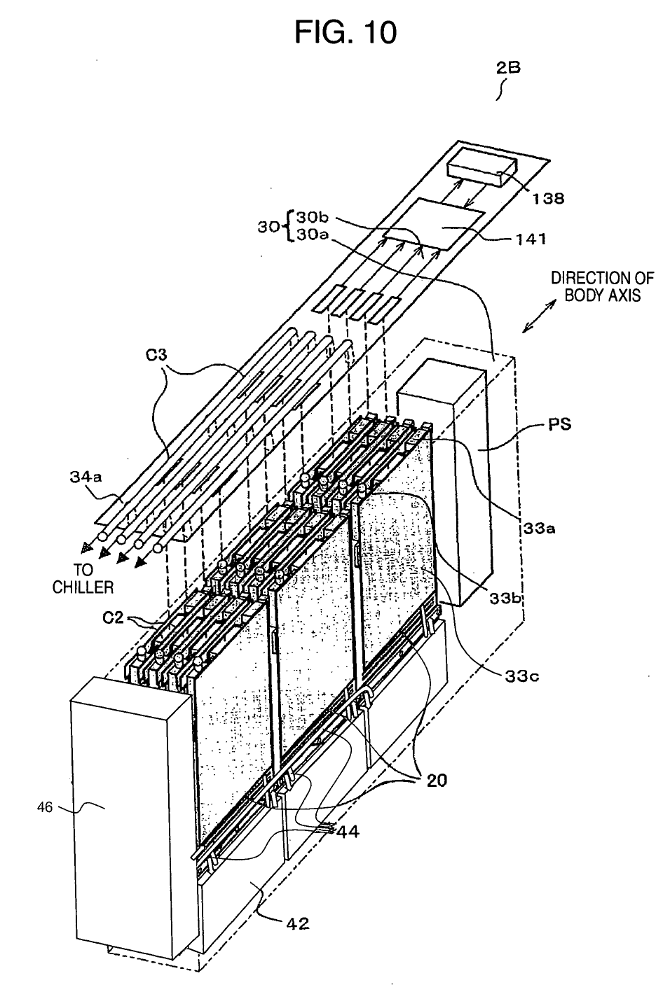

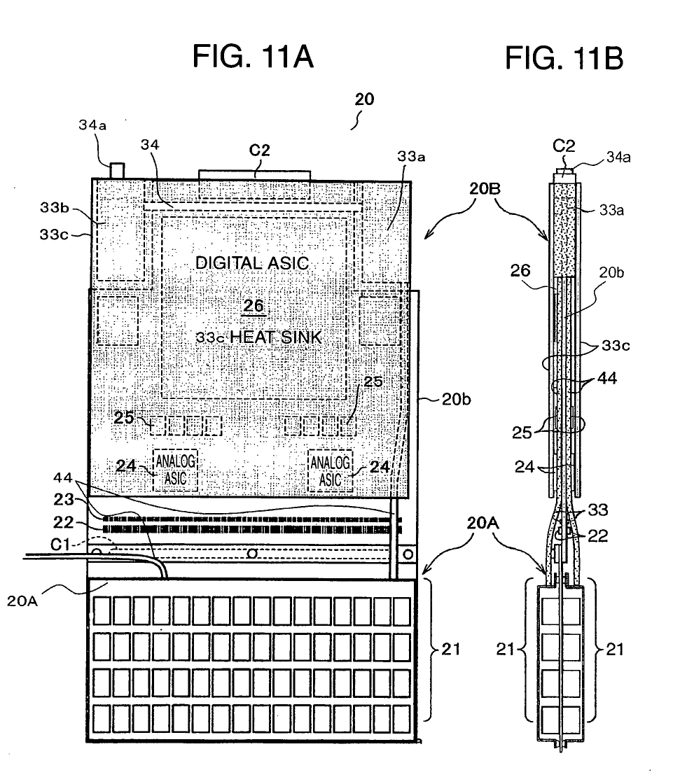

As shown in FIG. 19, the digital ASIC 26 comprises a plurality of packet data generation apparatuses 134, each of which includes eight time decision circuits (time information generation apparatuses) 135 and one ADC control circuit (ADC control apparatus) 136, and a data transfer circuit (data transmission apparatus) 137 and all these elements are integrated into one LSI. All the digital ASICs 26 provided in the PET apparatus receive a 500 MHz clock signal from a not shown clock generation apparatus (crystal oscillator) and operates synchronously. The clock signal inputted to each digital ASIC 26 is inputted to the respective time decision circuits 135 in all the packet data generation apparatuses 134. The time decision circuit 135 is provided for each of the detectors 21 and receives a timing signal from the timing pick off circuit 24a of the corresponding analog signal processing circuit 133. The time decision circuit 135 determines the detection time of γ-rays based on the clock signal when the timing signal is inputted. Since the timing signal is based on the fast processing system signal of the analog ASIC 24, a time close to a real detection time can be set as the detection time (time information). The ADC control circuit 136 receives a timing signal at which γ-rays are detected from the time decision circuit 135 and identifies the detector ID. That is, the ADC control circuit 136 stores a detector ID corresponding to each time decision circuit 135 connected to the ADC control circuit 136 and can identify, when time information is inputted from a certain time decision circuit 135, the detector ID corresponding to the time decision circuit 135. This will become possible because the time decision circuit 135 is provided for each of the detectors 21. Moreover, after inputting the time information, the ADC control circuit 136 outputs an ADC control signal including detector ID information to the ADC 25. The ADC 25 converts, to a digital signal, the peak value information outputted from the peak hold circuit 24e of the analog signal processing circuit 133 corresponding to the detector ID, and the ADC 25 outputs the information. The peak value information is inputted to the ADC control circuit 136. The ADC control circuit 136 adds the peak value information to the time information and detector ID to create packet data. The ADC control circuit 136 has a function as an ADC control apparatus to control the ADC 25 and information combination apparatus to combine the aforementioned time information and the peak value information. The information combination apparatus outputs combined information (packet information) being digital information including those three kinds of information. The packet data (including detector ID, time information, and peak value information) outputted from the ADC control circuit 136 of each packet data generation apparatus 134 is inputted to the data transfer circuit 137. The data transfer circuit 137 sends packet data, which is digital information outputted from the ADC control circuit 136 of each packet data generation apparatus 134, to the integrated circuit (unit combination FPGA (Field Programmable Gate allay)) 131 for unit combination that is provided for the housing 30 of the detector unit 2 (FIGS. 10, 11A and 11B) which houses twelve combined boards 20, for example, periodically. The unit combination FPGA (hereinafter referred to as “FPGA”) 131 transmits the digital information to the data processing apparatus 12 via an information transmission wire connected to the connector 138.

The present embodiment provides one ADC 25 to a plurality of analog signal processing circuit 133 inside one analog ASIC 24 since the ADC 25 converts, to a digital signal, the peak value information outputted from the peak hold circuit 24e corresponding to the detector ID information included in the control signal outputted from the ADC 25 control circuit. Accordingly, it is not necessary to provide one ADC 25 to one analog signal processing circuit 133 so that the circuit configuration of the ASIC board 20B can be considerably simplified. One information combination apparatus to generate combined information will be sufficiently provided to a plurality of analog signal processing circuit 133 inside one analog ASIC 24 so that the circuit configuration of the digital ASIC 26 can be simplified. In addition, one ADC control apparatus to specify the detector ID will be satisfactory to a plurality of analog signal processing circuit 133 inside one analog ASIC 24 so that the circuit configuration of the digital ASIC 26 can be simplified.

In this way, packet data which is outputted from the digital ASIC 26 and includes detector IDs for uniquely identifying (1) peak value information, (2) determined time information and (3) detector 21 is sent to the data processing apparatus 12 (FIG. 1) of the subsequent stage through the information transmission wire. The coincidence detection apparatus 12A of the data processing apparatus 12 carries out coincidence detection processing (when two γ-rays with predetermined energy are detected with a time window with a set time, a processing regards these γ-rays as a pair of γ-rays generated by annihilation of one positron) based on the packet data sent from the digital ASIC 26, counts the simultaneously measured pair of γ-rays as one γ-ray and locates, by using the detector IDs, the two detectors 21 which have detected the pair of γ-rays. When there are three or more γ-ray detection signals detected within the above time window (when there are three or more detectors 21 which have detected γ-rays), the data processing apparatus 12 identifies the two detectors 21 into which γ-rays are incident first out of three or more detectors 21 using peak value information, etc., on these γ-ray detection signals. The identified pair of detectors 21 is simultaneously measured and one count value is generated. Further, a tomographic information creation apparatus 12B of the data processing apparatus 12 creates tomographic information on the examinee at the position where radiopharmaceuticals are concentrated, that is, position of malignant tumor, using count values obtained by coincidence detection and position information on the detectors 21. This tomographic information is displayed on the display apparatus 13. Information such as the above digital information, count values obtained by coincidence detection, position information on the detectors 21 and tomographic information are stored in the storage apparatus of the data processing apparatus 12.

Incidentally, in the above explanation, the board body 20a (detector board 20A) for mounting the detectors 21 is different from the board body 20b (ASIC board 20B) for mounting the ASICs 24 and 26. Thus, when, for example, both ASICs are soldered to a board by means of a BGA (Ball Grid Allay) using reflow, only the ASIC board can be soldered, and therefore, this is preferable because it is not necessary to expose the semiconductor radiation detectors 21 to a high temperature. Of course, the connector C1 may be omitted when all the components 21 to 26 are placed on the same board.

(Detector Unit; Unit Construction Through Housing of Combined Board)

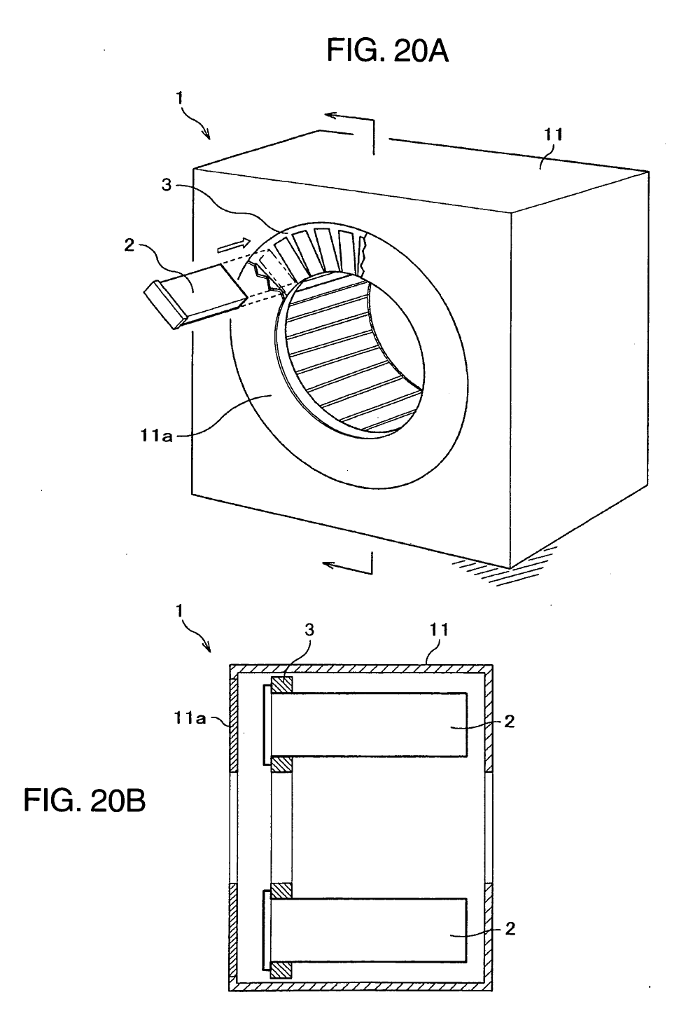

The following will describe a unit construction where the aforementioned combined board 20 is housed in the heat insulating covering 30. In the present embodiment, 12 combined boards 20 are housed in the heat insulating covering (frame) 30 to constitute a detector unit (12 board units) 2. The camera 11 of the PET apparatus 1 is configured so that 60 to 70 detector units 2 are arranged in the circumferential direction in a detachable/attachable manner (FIG. 20B) so as to facilitate maintenance and examination (FIG. 2).

(Placement in Heat Insulating Covering)

As shown in FIG. 5, the detector unit 2 is configured to house into a heat insulating covering 30 the aforementioned 12 combined boards 20, a high-voltage power supply PS for supplying a charge collecting voltage to those 12 combined boards 20. The heat insulating covering 30, which is formed of heat insulating material, comprises a housing 30a for housing the combined boards 20, a high-voltage power supply PS for supplying a charge collecting voltage to those 12 combined boards 20, and a connector for signals to exchange signals with the outside, and a ceiling plate 30b provided with the FPGA 131, the connector 138 for both of signals on signal exchange with the outside and the power supply for receiving power supply from the outside.

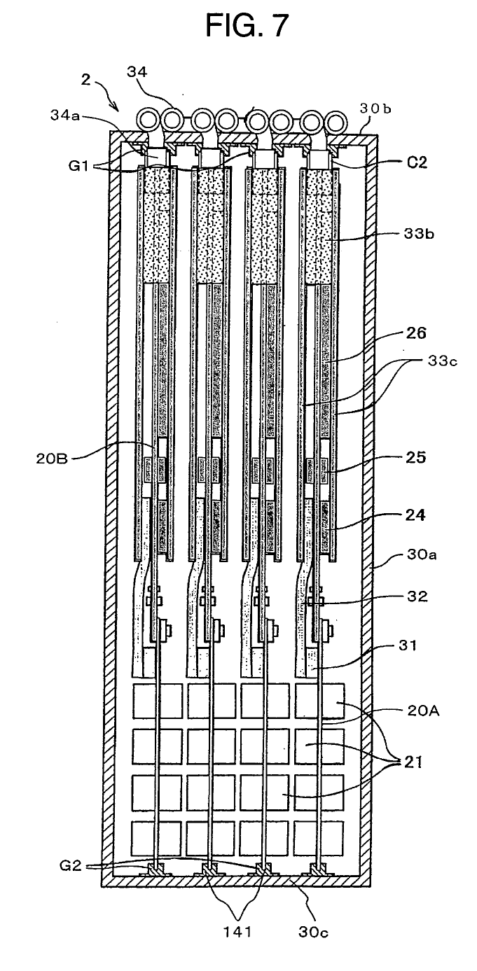

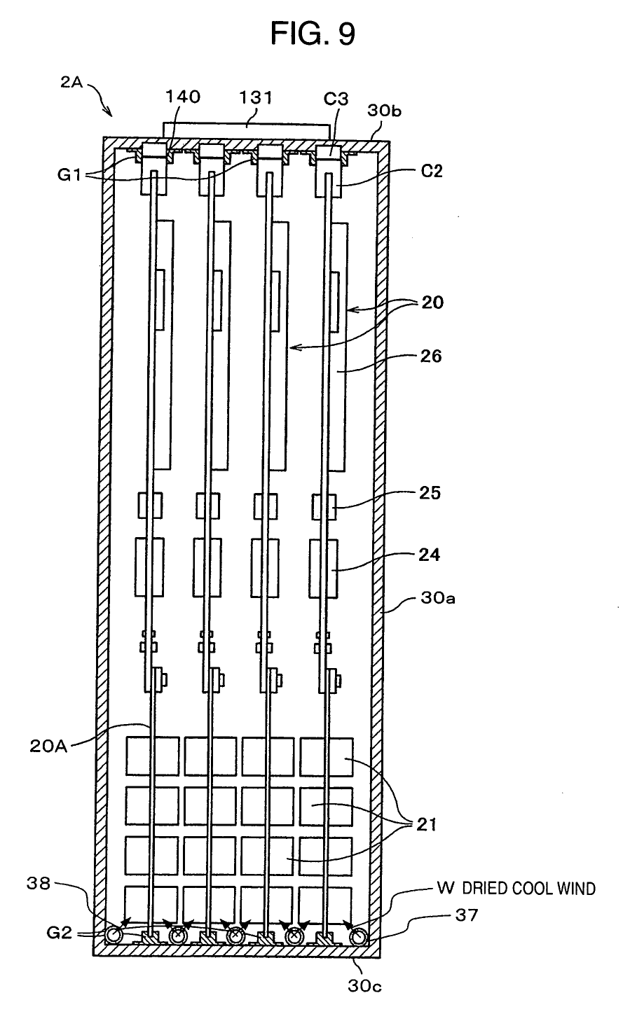

As shown in FIGS. 5 and 7, the combined boards 20 are housed in the housing 30a, arranged in three rows in the depth direction (longitudinal direction of the bed 14) without overlapping with one another and in four rows in the width direction (circumferential direction of the camera 11). That is, one housing 30a houses 12 combined boards 20. In order to realize such housing, a guide member 139, which consists of a group of four rows of guide grooves (guide rails) G1 extending in the depth direction and being arranged at appropriate intervals in the circumferential direction, is disposed in the housing 30a and is attached to the upper end of the housing 30a. The guide member 139 has an opening 140 (FIG. 9) opposed to each connector C3 of a ceiling plate 30b in the portion of each guide groove G1. Further, a bottom surface 30c of the housing 30a is provided with a group of four guide members 141 each of which has one guide groove (guide rail) G2 extending in the depth direction and are arranged at appropriate intervals in the circumferential direction (refer to FIG. 7). The guide grooves G1 and G2 have a depth corresponding to a capacity of housing three combined boards 20. An end of the combined board 20 on the ASIC board 20B side is housed in the guide groove G1 and an end of the combined board 20 on the detector board 20A side is housed in the guide groove G2. Three combined boards 20 are arranged to be held in the depth direction of the guide grooves G1 and G2. Incidentally, since the end of the combined board 20 on the ASIC board 20B side and the other end on the detector board 20A side slide in the guide grooves G1 and G2, the combined boards 20 can be readily positioned at predetermined points by sliding the combined boards 20 in the guide grooves G1 and G2 with fingers and the like. In this case, each board connector C2 is disposed in the portion of each opening 40. After a predetermined number of combined boards 20 are arranged in the housing 30a, the ceiling plate 30b is attached at the top end of the housing 30a in a detachable/attachable manner using screws, etc. Each connector C3 provided on the ceiling plate 30b is inserted in the corresponding opening 140 and is connected to the corresponding board connector C2. Incidentally, the terms “upper” and “lower” parts of the housing 30a are applicable when the housing 30 is removed from the camera 11, and when the housing 30a is mounted in the camera 11 as shown in FIG. 2, the upper and lower parts may be inverted or turned 90 degrees to be “right” and “left” parts or located diagonally.

As shown in FIG. 5, the ceiling plate 30b comprises not only the aforementioned four rows of guide grooves G1 but also FPGA 131 and connector 138. The connector 138 is connected to the FPGA 131. The FPGA 131 is programmable in the field. In this aspect, the ASIC, which is not programmable, is different. Therefore, as FPGA 131 with this embodiment, even if the number or type of the combined boards 20 to be housed changes, it is possible to properly respond to changes in the number thereof by programming in the field.

Incidentally, since the detectors 21 containing CdTe as the semiconductor material S in this embodiment generate charge in reaction to light, the housing 30a and the ceiling plate 30b are made of a material such as aluminum and an alloy of aluminum that have light shielding properties. The heat insulating covering 30 is configured so as to eliminate gaps permitting the entry of light, giving rise to light shielding properties.

As shown in FIG. 20A, the detector unit 2 is mounted via a unit support member 3. Furthermore, as shown in FIG. 20B hereof, the detector unit 2 is mounted in the camera 11 with one end supported by the unit support member 3. The unit support member 3 has a hollow disk (doughnut) shape and comprises many windows (as many as the detector units 2 to be mounted) in the circumferential direction of the camera 11. In order to support the detector units 2 at one end, a flange portion serving as a stopper is provided on the front side in the axial direction of the housing 30a of the detector unit 2. Incidentally, the flange portions inside in the circumferential direction become obtrusive when the detector units 2 are arranged as dense as possible in the circumferential direction. Therefore, the obtrusive flange portions hereof may be removed from the housing 30a to allow the flange portions outside in the circumferential direction to remain. Another unit support member 3 may be provided and both ends of the detector unit 2 may be supported by the two unit support members 3.

As mentioned above, in order that each detector unit 2 is mounted to the unit support member 3, those detector units 2 are disposed so as to surround the circumference of the bed 14. In the detector units 2, all the detectors 21 are disposed closer to the bed 14 than to the integrated circuits of the analog ASICs 24 and the digital ASIC 26.

In the present embodiment, the detector units 2 are mounted to the unit support members 3, enabling a great number of detectors 21 to be mounted onto the camera 11 at a time. Therefore, time for mounting the detectors 21 onto the camera 11 can be considerably shortened. In addition, the packet data outputted from the data transfer circuit 137 of all the combined boards 20 in the detector units 2 (all the packet data for all the detectors 21 of the combined boards 20) are sent from the unit combination FPGA 131 to the data processing apparatus 12. This serves to considerably reduce the number of wires to transmit the packet data to the data processing apparatus 12 in the present embodiment even if compared with the case where the packet data is sent respectively from the respective data transmission circuit 137 of the combined boards 20 to the data processing apparatus 12.

When the detector units 2 is mounted in the camera 11, a cover 11a is removed to make the unit support member 3 exposed and the detector units 2 are inserted therefrom until the detector units 2 touch the flange portions. Incidentally, when the detector units 2 are inserted and mounted, the camera 11 and the connectors of the detector units 2 are connected to each other, and signals and power supply are connected between the camera 11 and the detector units 2.

(Power Supply)

The following will describe the high-voltage power supply apparatus PS for supplying voltage for collecting charge. As shown in FIG. 5, the detector unit 2 is provided with the high-voltage power supply apparatus PS for supplying charge collection voltage to each of the detectors 21. This high-voltage power supply apparatus PS is arranged to receive a low direct voltage power supply from an outside power supply (not shown) via a connector 138, to boost the voltage to 300 V using a DC-DC converter (first voltage boosting apparatus, not shown) and to supply the voltage to each of the detectors 21. Incidentally, for each of the combined boards 20 (=detector boards 20A), 64 detectors 21 are provided on one side and thus 128 detectors 21 are provided on both sides. Twelve such combined boards 20 are housed in one detector unit 2. Thus, the first voltage boosting apparatus supplies voltages to 128×12=1536 detectors 21.

Cooling Mechanism

The following will describe a cooling mechanism for cooling semiconductor radiation detector characterizing the present embodiment. As shown in FIG. 5, a detector unit 2 is provided with a Peltier device 31 being a cooling mechanism (cooling apparatus) internally. A detector board 20A, a board body 20a in particular, is formed of material with good heat conductance, for example, aluminum nitride (AlN) or carbon complex board having copper foil, etc. As shown in FIGS. 6A, 6B and 7, the Peltier device 31 is disposed in one side of the upper end of each detector board 20A. The Peltier devices 31 are brought into electrical connection with the power supply connectors 31a for the Peltier devices provided corresponding to respective Peltier devices 31 on the ceiling plate 30b. The respective Peltier devices 31 are connected to a heat pipe 32 on a surface opposing the side contacting the detector board 20A thereof. The heat pipe 32 is thermally connected to a later-described heat sink 33c.

Further, the detector unit 2 comprises another cooling mechanism (cooling apparatus) for cooling integrated circuits, that is, analog ASICs 24 and a digital ASIC 26. The cooling mechanism hereof includes cooling jackets 33a and 33b, heat sink 33c, a coolant pipe 34, a coolant chiller unit (radiator) 35. As shown in FIGS. 5, 6A, 6B and 7, four analog ASICs 24 mounted on the both faces of the board body 20b of each ASIC board 20B and one digital ASIC 26 mounted on one surface of the board body 20b are connected to the heat sinks 33c made of copper or aluminum in thickness of 2 mm placed on the both sides of the board 20b and the heat sinks 33c are respectively attached to sandwich the cooling jackets 33a and 33b attached to a cutout area in an upper end part of the board 20B. The cooling jackets 33a and 33b are respectively brought into communication through the coolant pipe 34 which are brought into communication with the coolant chiller unit 35 placed at a side part of the housing 30a via a connector for the coolant pipe provided in the ceiling plate 30b as shown in FIG. 5. As coolant, for example, antifreeze solution of glycolic family containing metal corrosion inhibitor and silicon oil, etc. are used. Since the temperature of coolant may be around the room temperature at a room where the PET apparatus 1 is installed, a water-cooling cooling unit used for a water-cooled PC and the like may be used as the coolant chiller unit 35.

In the cooling mechanism hereof, the Peltier device 31 is supplied with current from the power supply connector for Peltier device 31a, the detector board 20 in contact with the Peltier device 31 is cooled. And heat deprived by the Peltier device 31 and heat generated by the Peltier device 31 are radiated via the heat pipe 32 connected to the Peltier device 31. At this time, in each combined board 20, the coolant is circulated/distributed from the coolant chiller unit 35 through the coolant pipe 34 into the cooling jackets 33a and 33b that are brought into communication by that cooling pipe 34 to cool four analog ASICs 24 and one digital ASIC 26 through the heat sink 33c. Further, heat deprived from the detectors 21 is radiated from the heat pipe 32 that is thermally connected to the cooling jacket 33a.

The following will describe, in particular, application of voltage (current supply) to the Peltier device 31 and the coolant chiller unit 35 in the present embodiment. Application of voltage to the Peltier device 31 and the coolant chiller unit 35 is conducted by a high-voltage power supply apparatus PS. The high-voltage power supply apparatus PS comprises another DC-DC converter (second voltage transforming apparatus, not shown) besides the DC-DC converter (first voltage transforming apparatus 1) for supplying voltage for collecting charge. The second voltage transforming apparatus hereof transforms a low direct current voltage supplied from the above-described outside power supply via the connector 138 to about 10V so as to supply respectively to the Peltier device 31 via the power supply connector 31a for Peltier device and to the coolant chiller unit 35.

In the present embodiment, coolant cooled with the coolant chiller unit 35 is used to cool the analog ASICs 24 and the digital ASIC 26, but the coolant chiller unit 35 may be replaced with an air chiller unit so that air cooled with the air chiller unit hereof is used to cool the analog ASICs 24 and the digital ASIC 26.

Thus, the detector 21 is cooled by way of the board body 20a in contact with the Peltier device 31. Cooling the detectors 21 hereof can attain effects to improve physical performance on the semiconductor material S configuring the detectors 21, including: (1) decrease in leak current (reduction of noise), (2) improvement in mobility of generated charge (shortening of rise time of the detected signals, improvement in efficiency of collecting charge, decrease in insensitive time), (3) increased life of generated charge (improvement in efficiency of collecting charge), (4) reducing of polarization (stabilization of performance of elements), etc. With these effects, effects of the aforementioned (1) through (3) improve energy resolution of the detectors 21 in the PET apparatus 1, making improvements attainable such as (a) improvement on accuracy in removing scattered ray, shortening of time of detection time signals resulting in (b) improvement on accuracy in detection time signals, and decrease in insensitive time resulting in (c) improvement in count rate. That is, a collective effect hereof leads to improvement in NECR (Noise equivalent count rate: an indicator corresponding to S/N ratio) representing the ratio of a real γ-ray signal indicating the position of a tumor to a scattered ray and chance coincidence events, and based on the above-described tomographic information, contrast on an image displayed in the display apparatus 13 can be improved. With contrast of images being conventionally treated, detection time can be considerably shortened.

In addition, the physical effect of (4) can reduce problems such as displacement of charge peak to be presented by the semiconductor radiation detectors 21 so as to enable stabler operation for a long time without addressing complicated measures.

Moreover, in comparison in terms of the same performance as in systems prior to application of the present embodiment, simplification can be expected in apparatus configuration as in that voltage of detector bias decreases and thickness of detection elements may be thick, etc.

Since employment of a cooling mechanism of detectors 21 by way of the board body 20a makes it unnecessary to secure a space for cooling air to pass compared with simple air cooling, placement density of the detectors 21 in the detector board 20A can be considerably increased. Moreover, air cooling by way of the air in the room temperature requires a substantial amount of cooled air flow, giving rise to concern about effects of noise on γ-ray detection signals due to aerodynamic vibration and the like. The present embodiment does not give rise to such a problem.

The present embodiment provides the cooling mechanism (Peltier device 31, coolant chiller unit 35, etc.) to each detector unit 2 so that the cooling mechanism can be miniaturized. This contributes to downsize a nuclear medicine imaging apparatus. Since the cooling mechanism is provided to each detector unit 2, cooling efficiency on each detector 21 can be improved.

In the present embodiment, since the high-voltage power supply apparatus PS transforms a low voltage applied from an outside direct power supply to 300 V with the first transforming apparatus and to about 10V with the second transforming apparatus respectively, high-voltage portion can be made less. This serves to shorten insulation distance. That is, high-voltage wiring from the connector 42 to the direct power supply is longer necessary. In addition, maintenance gets easier.

In the present embodiment, since the first and the second transforming apparatus is disposed at one end of the bed 14 in the longitudinal direction, distance between respective detector units 2 adjacent each other in the circumferential direction can be made narrower. This will enable the detector 21 to be densely disposed in the circumferential direction thereof, contributing to increase in detection efficiency on γ-ray. The coolant chiller unit 35 is also disposed at the other end of the bed 14 in the longitudinal direction, distance between respective detector units 2 adjacent each other in the circumferential direction keeps the narrow state.

Since the detector unit 2 is removable from the PET apparatus 1, maintenance and examination on the cooling mechanism can be simpler. Since the cooling mechanism is provided to each detector units 2, the cooling mechanism can be examined on each detector unit 2.

Next, another example of the detector unit of a semiconductor radiation detector is shown in FIGS. 8 and 9. In the detector unit 2A of this semiconductor radiation detector, the combined board 20, the housing 30a, the ceiling plate 30b, the board connector C2 as well as the high-voltage apparatus PS besides cooling mechanism have configurations similar to the detector unit 2 shown in the aforementioned FIGS. 5 to 7 and the configurations hereon will be omitted. Incidentally, the high-voltage apparatus PS includes the first transforming apparatus but does not comprise the second transforming apparatus, shown in FIG. 5, described with respect to the cooling mechanism. The following will describe the cooling mechanism in the detector unit 2A hereof.

Cooling Mechanism

As shown in FIG. 8, the detector unit 2A together with the high-voltage apparatus PS for supplying charge collecting voltage to each detector 21 are enclosed in the heat insulating covering 30. The heat insulating covering 30 is configured to comprise combined boards 20, a high-voltage apparatus PS for supplying a charge collecting voltage to those 12 combined boards 20, a housing 30a for housing a connector for signals to exchange signals with the outside, and a ceiling plate 30b provided with the connector for the power supply for receiving power supply from the outside, and is formed of heat insulating material. On the both sides of the housing 30a, a pair of chiller units 36a and 36b for generating dried cool wind in the temperature equal to or lower than the temperature of the room where the PET apparatus is installed are provided. These chiller units 36a and 36b are brought into communication with a plurality of cool wind pipes 37 arranged on the bottom surface 30c. The cool wind pipes 37 are arranged along each combined board in the longitudinal direction in the space between the guide grooves G2 where the bottom end of each combined board 20 is fitted, and in the space between a guide groove G2 and side wall of the housing 30a, and as shown in FIG. 9, cool wind supply openings 38 in order to blow out the cool wind toward the upper detector 21 are bored. In addition, the ceiling plate 30b is provided with ventilating holes 39 being openings that are subject to electromagnetic shield with metal mesh.

In this cooling mechanism, dried cool winds WA and WB are blown into the cool wind pipes 37 from the both sides of the housing 30a out of the chiller units 36a and 36b. The blown-in dried cool winds WA and WB are distributed through the cool wind pipes 37 and blown out toward each detectors 21, as shown in FIG. 9, from the cool wind supply openings 38. The dried cool winds WA and WB hereof cool the detectors 21. In addition, after cooling the detectors 21, the dried cool winds WA and WB flow toward the integrated circuit side in the space in the heat insulating covering 30 of the detector unit 2 so as to cool the analog ASICs 24, ADCs 25 and digital ASIC 26 to be ventilated from the ventilating holes 39. At this time, the chiller units 36a and 36b are supplied with power from the outside of the PET apparatus through power supply lines 41a and 41b from the outside power supply (not shown). Power supply to the chiller units 36a and 36b may be conducted by a second transforming apparatus, such second transforming apparatus being provided in the high-voltage apparatus PS likewise the example shown in FIG. 5 instead of the power supply lines 41a and 41b.

Thus, the detector 21 is cooled. Effects similar to those for the cooling mechanism described with reference to FIG. 5 to FIG. 7 are attainable.

In addition, the dried cool wind subject to cooling the detector 21 cools each ASIC of the board 20B instantly, and therefore can cool more efficiently than a normal room temperature air cooling. Accordingly, introduction of low flow quantity can serve well, a large fan can be removed and noise problems can be reduced.

That is, it is preferable to cool the detectors 21 to a temperature lower than the aforementioned room temperature and the integrated circuits may be cooled in a temperature range equal to or higher than the room temperature but not so high. The cooling mechanism of the present embodiment is configured to circulate the dried cool wind (in a temperature equal to or lower than the aforementioned room temperature) blown out from the cool wind supply openings 38 of the cool wind pipes 37 into the heat insulating covering 30 toward a region where integrated circuits with large heat values are disposed from a region where the detectors 21 are disposed in the heat insulating covering 30, so that the detector 21 can be cooled with the dried cool wind in advance. This increases cooling efficiency of the detectors 21. In addition, since the detectors 21 generate little heat, the integrated circuits can be cooled with the dried cool wind subject to cooling the detectors 21. In the present embodiment, as compared with the case where dried cool air for cooling the detectors 21 and the dried cool wind for cooling the integrated circuits are supplied separately, required flow amounts of dried cool wind can be considerably reduced.

Next, still another example of the detector unit of a semiconductor radiation detector is shown in FIGS. 10 to 12. In the detector unit 2B of this semiconductor radiation detector, the combined board 20, the housing 30a, the ceiling plate 30b, the board connector C2, connector C3 as well as the high-voltage apparatus PS besides cooling mechanism have configurations similar to the detector unit 2 shown in the aforementioned FIGS. 5 to 7 and the configurations hereon will be omitted. Accordingly, the following will describe the cooling mechanism in the detector unit 2B hereof.

Cooling Mechanism

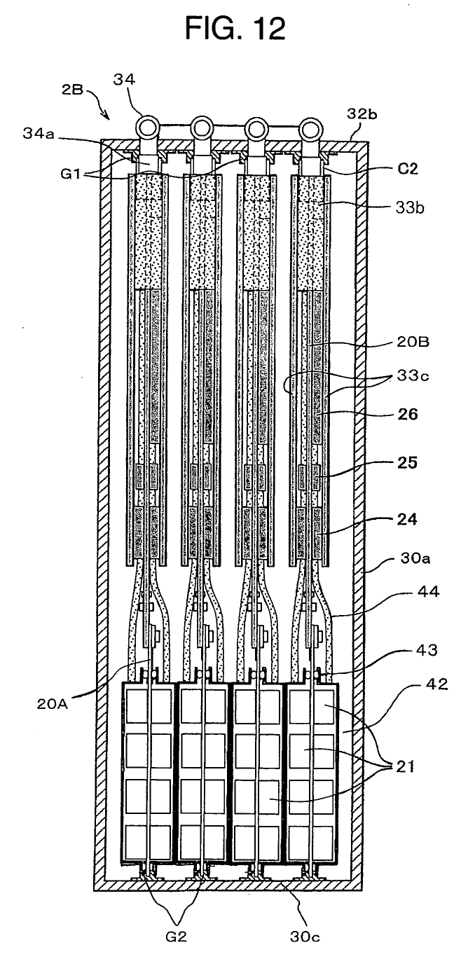

As shown in FIG. 10, the detector unit 2B is configured by covering a plurality of combined boards 20 and the high-voltage power supply apparatus PS for supplying charge collecting voltage to each detector 21 with the heat insulating covering 30. The heat insulating covering 30 has 12 combined boards 20, a high-voltage power supply apparatus PS for supplying a charge collecting voltage to those 12 combined boards 20, a housing 30a for housing a connector for signals to exchange signals with the outside, and a ceiling plate 30b provided with the connector for the power supply for receiving power supply from the outside, and is formed of heat insulating material. The heat insulating covering 30 does not necessarily need to have heat insulating property but it is preferable to have heat insulating property in order to enhance cooling efficiency. The detector boards 20A together with detectors 21 are housed in the sealed container 42 as shown in FIGS. 11A, 11B and 12. The sealed containers 42 are attached to the detector boards 20A in a liquid-tight manner with packing 43. As shown in FIG. 10, the adjacent sealed containers each other are brought into communication with the heat insulating coolant pipe 44. The high-voltage apparatus PS includes a first transforming apparatus for applying voltages to detectors 21 and a second transforming apparatus for applying voltages to the later-described coolant chiller units 46.

As shown in FIGS. 10 to 12, four analog ASICs 24 mounted on the both faces of the board body 20b of each ASIC board 20B and one digital ASIC 26 mounted on one surface of the board body 20b are connected to the heat sinks 33c made of copper or aluminum in thickness of 2 mm placed on the both sides of the board 20b and the heat sinks 33c are respectively attached to sandwiched between the cooling jackets 33a and 33b attached to a cutout area in an upper end part of the board 20B. The cooling jackets 33a and 33b are respectively brought into communication through the coolant pipe 34 which are brought into communication with the coolant chiller unit 46 placed at a side part of the housing 30a via a connector for the coolant pipe provided in the ceiling plate 30b as shown in FIG. 10. The coolant chiller unit 46 produces a coolant in a temperature lower than the room temperature. As coolant, low-viscosity insulating liquid is preferable, and, for example, antifreeze solution of glycolic family containing metal corrosion inhibitor and silicon oil, etc. are used. Cooling configuration for the boards 20B is approximately the same as the prior example shown in FIGS. 5 to 7. It is possible to use an electronic cooling device using Peltier device instead of the coolant chiller unit 46.

However, in this cooling mechanism, the coolant is circulated/distributed from the coolant chiller unit 46 through the coolant pipe 44 to the sealed container 42 and the cooling jackets 33a and 33b in this order to cool the detectors 21 disposed in the detector boards 20A, four analog ASICs 24 and one digital ASIC 26 attached to the heat sink 33c.

Thus, the detector 21 is cooled. Effects similar to those for the cooling mechanism described with reference to FIG. 5 to FIG. 7 are attainable.

In addition, in this cooling mechanism, all the circumference of the detector element 20a is covered with cooled insulating liquid, and therefore cooling is conducted uniformly and at the same time a problem due to dew formation in the detector element 20a can be avoided. Moreover, this low temperature coolant is used as the coolant for the board 20B as is so that the entire system can be cooled efficiently.

[Embodiment 2]

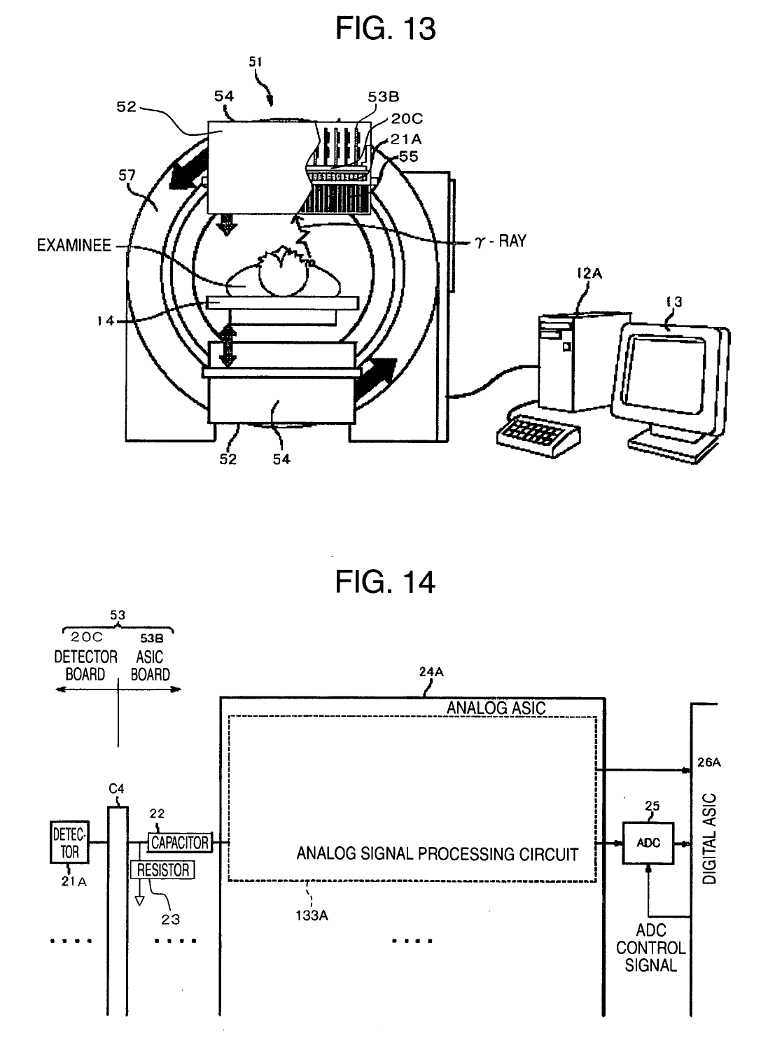

Next, Embodiment 2 will be described with a SPECT apparatus as an example. This SPECT apparatus 51 will be described with reference to FIGS. 13 to 16 and FIG. 21. The SPECT apparatus 51 comprises, as shown in FIG. 13, a pair of radiation detectors 52, a rotating support stand 57, a data processing apparatus 12A and a display apparatus 13. Those radiation detectors 52 are disposed in a rotation support stand 57 in positions subject to displacement such as 180° and 90° in the circumferential direction. In addition, the radiation detectors 52 respectively rotates independently so as to enable incident angles to change and with 2 units being arranged side by side the imaging area can be extended, or otherwise the radiation detectors 52 can be used as a gamma camera to conduct plane imaging. A radiation detector 52 comprises 32 sets of ASICs boards 53B and one detector board 20C, detectors 21A and a collimator 55, configuring itself one camera unit. The ASIC board 53B is attached to the detector board 20C in a detachable/attachable manner. Except for that configuration, the combined board 53 has the same configuration as in the detector unit 2 in the Embodiment 1.

The combined board 53 has the detector board 20C and the ASIC board 53B similar to the aforementioned combined board 20 (FIG. 14). The detector 21A placed at the tip of the detector board 20C is positioned at the side of the bed 14. The collimators 55 made from a radiation shielding material (for example, lead or tungsten, etc.) are provided to respective radiation detectors 52. Each collimator 55 forms a great number of radiation paths where radiations (for example, γ-ray) passes. All the combined board 53 are placed in light shielding/electromagnetic shield 54 provided to the rotation support stand 57. The collimators 55 are attached to the light shielding/electromagnetic shield 54 in a detachable/attachable manner. The light shielding/electromagnetic shield 54 shields the effect of electromagnetic wave onto the detectors 21, and shields γ-ray from sources other than the collimator with internally-pasted lead.

The detector board 20C used in the present embodiment is different from the detector board 20A, and has configuration in which a plurality of detectors 21A are installed in the board body 20a for configuration and is configured by attaching anode A and cathode C onto the both surfaces of one detection element 211. The detector 21A is installed so that one end face of the detection element 211 faces the board body 20a and the anode A and cathode C are disposed perpendicular to the board body 20a.

The ASIC board 53B configuring the combined board (unit board) 53, as shown in FIG. 14, is brought into connection with the detector board 20C by the connector C4, and the ASIC board 53B has capacitance 22, resistor 23, 4 analog ASICs 24A and one digital ASIC 26A provided to each detector 21A.

The cooling mechanism being characteristic for the present embodiment will be described later, and operation of these apparatuses as a whole will be described in advance.

An examinee to whom radiopharmaceuticals have been administered is lying on the bed 14, which is relocated and the examinee is moved to a position between a pair of radiation detectors 52. The rotation support stand 57 is caused to rotate, so that each radiation detector 52 turns around the examinee. A γ-ray emitted from the concentrated part C (for example, an affected area) in the examinee where radiopharmaceuticals are concentrated is incident onto the corresponding detector 21 through the radiation path of the collimator 55. The detector 21A outputs a γ-ray detection signal. This γ-ray detection signal is transmitted to the ASIC board 53B via the detector board 20C and the connector C4, and is processed with the later-described analog ASIC 24A and digital ASIC 26A.

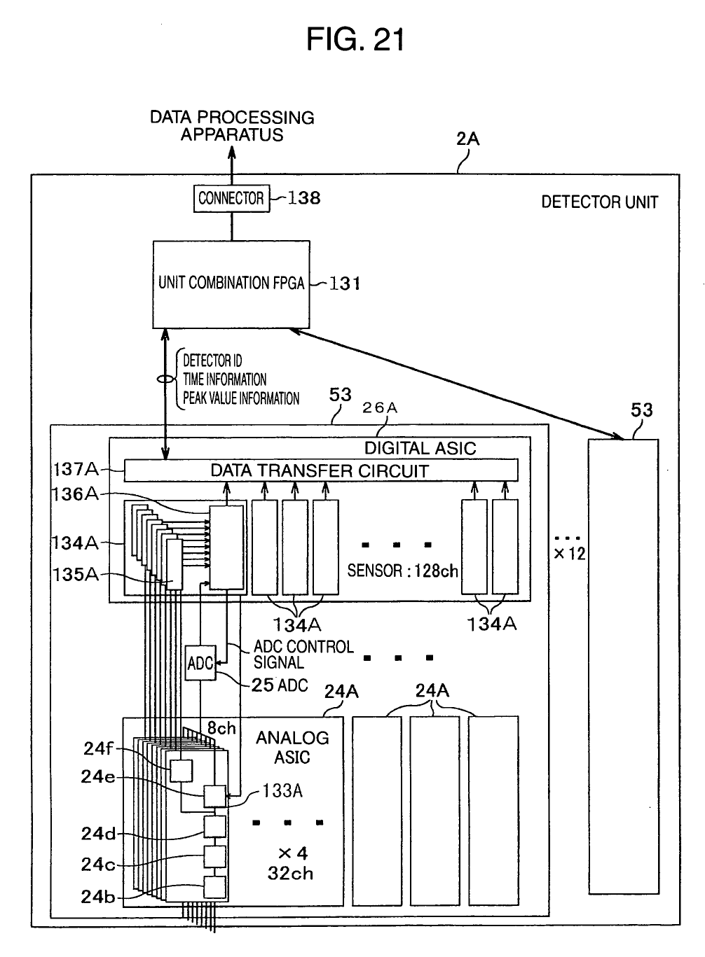

The ASIC board 53B configuring the present combined board 53 will be described with reference to FIGS. 14 and 21. The ASIC board 53B is brought into connection with the detector board 20C with the connector C4 likewise the combined board 20, and the ASIC board 53B has capacitance 22, resistor 23, 4 analog ASICs 24A and one digital ASIC 26A provided to each detector 21A. One analog ASIC 24 comprises 32 sets of analog signal processing circuits (analog signal processing apparatus) 133A. The analog signal processing circuit 133A is provided for each of the detectors 21A. The analog signal processing circuit 133A comprises a trigger output circuit 24f to output a trigger signal for identifying detection of γ-rays. In addition, likewise the analog ASIC 24, the analog signal processing circuit 133A comprises a charge amplifier 24b, a polarity amplifier 24c, a band pass filter 24d and a peak hold circuit 24e connected in this order. One analog ASIC 24A is an LSI which integrates 32 sets of analog signal processing circuits 133A. A γ-ray detection signal outputted from the detector 21 and passed through the capacitor 22 is inputted to the peak hold circuit 24e via the charge amplifier 24b, the polarity amplifier 24c, and the band pass filter 24d. The peak hold circuit 24e holds the peak value of a γ-ray detection signal. The γ-ray detection signal outputted from the bandpass filter 24d is inputted to the trigger output circuit 24f. The trigger output circuit 24f outputs a trigger signal when a γ-ray signal at equal to or higher than a set level in order to remove effects from noises.

The digital ASIC 26A has a packet data generation apparatuses 134A and a data transfer circuit 137, and these elements are integrated into one LSI. The above-described trigger signal is inputted to the ADC control circuit 136A of the packet data generation apparatuses 134A. All the digital ASICs 26A provided in the SPECT apparatus 51 receive a 64 MHz clock signal from a not shown clock generation apparatus (crystal oscillator) and operate synchronously. The clock signal inputted to each digital ASIC 26A is inputted to the respective ADC control circuits 136A in all the packet data generation apparatuses 134A. The ADC control circuits 136A identify the detector ID when a trigger signal is inputted. That is, the ADC control circuit 136A stores a detector ID corresponding to each trigger output circuit 24f connected to the ADC control circuit 136A and can identify, when a trigger signal is inputted from a certain trigger output circuit 24f, the detector ID corresponding to the trigger output circuit 24f. The ADC control circuit 136A outputs the ADC control signal including the detector ID information to the ADC 25. The ADC 25 converts, to a digital signal, the peak value information outputted from the peak hold circuit 24e of the analog signal processing circuit 133A corresponding to the detector ID, and the ADC 25 outputs the information. The peak value information is inputted to the ADC control circuit 136A. The ADC control circuit 136A adds the peak value information to the detector ID to create packet data. The packet data (including detector ID and peak value information) outputted from the ADC control circuit 136A of each packet data generation apparatus 134A is inputted to the data transfer circuit 137. The data transfer circuit 137 sends packet data outputted from each ADC control circuit 36A to the unit combination FPGA 131 of the detector unit 2A periodically. The unit combination FPGA 131 outputs the digital information to the information transmission wire connected to the connector 138.

Each packet data outputted from the unit combination FPGA 131 is transmitted to the date processing apparatus 12A (FIG. 13). To the data process apparatus 12, the rotation angle detected with an angle gauge (not shown) connected to the rotation axis of the motor (not shown) rotating the rotation support stand 57 is inputted. This rotation angle specifies the rotation angle of the respective radiation detectors 52, and specifies in particular the rotation angles of the respective detectors 21A. Based on this rotation angle, the data processing apparatus 12A calculates the position (position coordinate) on the rotation track of the rotating respective detectors 21A. Thus, the position (position coordinate) of the detector 21A at the point of time when a γ-ray is detected is calculated. Based on the calculated position of the detector 21A, the data processing apparatus 12A calculates the γ-ray involving peak value information that gets equal to or higher than a set value. This counting is conducted on respective regions obtainable by way of sectioning every 2 to 9° with the rotation center of the rotation support stand 57 as a standard. The data processing apparatus 12A creates tomographic information on the examinee at the position where radiopharmaceuticals are concentrated, that is, position of malignant tumor, using position information on the detectors 21A at the time point when a γ-ray is detected and the count values (count information) of a γ-ray. This tomographic information is displayed on the display apparatus 13. Information such as the above packet information, position information on the detectors 21A and tomographic information are stored in the storage apparatus of the data processing apparatus 12A.

Cooling Mechanism

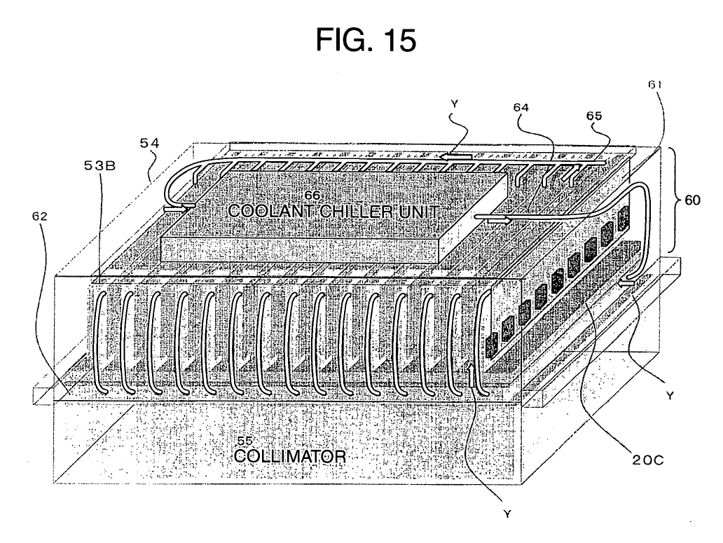

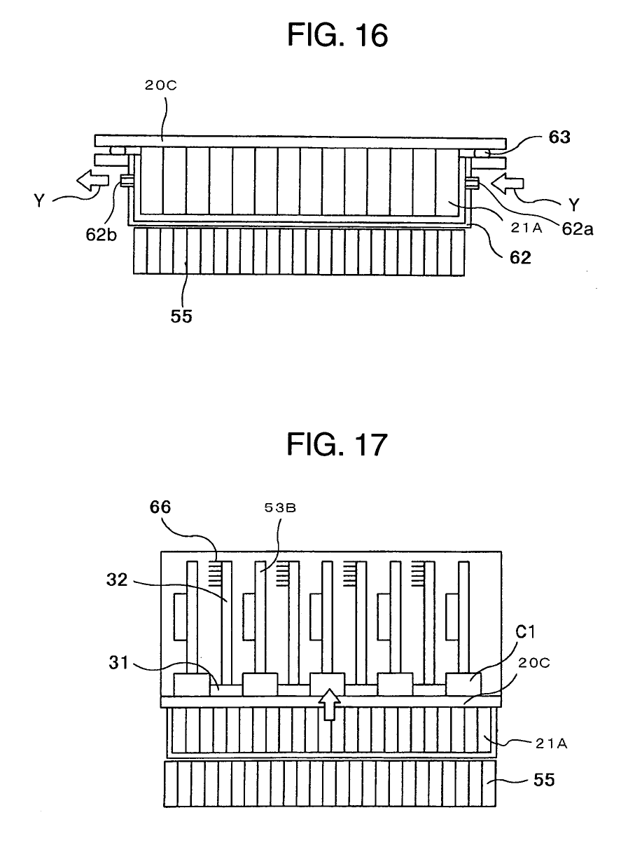

The following will describe a cooling mechanism for cooling semiconductor radiation detector characterizing the present embodiment. As shown in FIG. 15, the detector unit 60 configured with a combined boards 53 being arranged is enclosed in the light shielding/electromagnetic shield 54. The detector boards 20C together with detectors 21A are housed in the sealed container 62 as shown in FIG. 16. The sealed containers 62 are attached to the detector boards 20C in a liquid-tight manner with packing 63 and have a coolant inlet 62a and a coolant outlet 62b.

In addition, as shown in FIG. 15, a plurality of analog ASICs 24A mounted on the both faces of the board body 53b of each ASIC board 53B and several digital ASICs 26 mounted on one surface of the board body 53b are connected to the heat sinks 61 made of copper or aluminum in thickness of 2 mm placed on the both sides of the board body 53b as in Embodiment 1 and the heat sinks 61 are respectively attached to sandwich the cooling jackets 64 attached to a cutout area in an upper end part of the ASIC board 53B. The cooling jackets 64 are respectively brought into communication through the coolant pipe 65 which are brought into communication with the coolant chiller unit 66 placed at an upper part of the heat insulating covering via a connector for the coolant pipe as shown in FIG. 15. This configures a flow path where the coolant is circulated/distributed through coolant chiller unit 66→sealed container 62→cooling jacket 64→coolant chiller unit 66 in this direction (in the direction of the arrow Y in FIG. 15). It is possible to use an electronic cooling device using Peltier device instead of the coolant chiller unit 66 likewise the coolant chiller unit shown in FIG. 10.

As coolant, low-viscosity insulating liquid is preferable, and, for example, antifreeze solution of glycolic family containing metal corrosion inhibitor and silicon oil, etc. are used. Cooling configuration for the boards 53B is approximately the same as Embodiment 1 shown in FIGS. 5 to 7.

In this cooling mechanism, the coolant is circulated/distributed from the coolant chiller unit 65 through the coolant pipe 65 to the sealed container 62 and the cooling jackets 64 in this order to directly cool the detectors 21A disposed in the detector boards 20C, and to indirectly cool the analog ASICs 24A and digital ASICs 26 through the heat sink (FIG. 15).

Thus, the detector 21A is cooled. Effects to improve physical properties obtainable accompanied by cooling the detectors are as described in the Embodiment 1, and in the SPECT apparatus in particular, improvement in energy resolution improves accuracy in removal of scattered rays. That is, S/N ratio being the real γ-ray signal indicating the position of a tumor to the scattered rays increases so as to improve image contrast dramatically. Or, with the image of the same level, shortening of imaging time can be expected. The effects of reducing of polarization and simplification of the apparatus, etc. are likewise the PET apparatus of Embodiment 1.

Next, FIG. 17 exemplifies another cooling mechanism of the detector unit.

In the detector unit having this cooling mechanism, as shown in FIG. 17, Peltier devices 31 are disposed on the surface opposite from the detectors of the detector board 20C and in the space between the ASIC boards 53B respectively. A detector board 20C is formed of material with good heat conductance, for example, aluminum nitride (AlN) or carbon complex board having copper foil, etc., and respective Peltier devices 31 are brought into connection with the heat pipe 32 on the surface opposite from the side in contact with the detector board 20C.

In the cooling mechanism hereof, when the Peltier device 31 is supplied with current from the power supply connector for Peltier device (not shown), the detector board 20C in contact with the Peltier device 31 is cooled, and heat is deprived from detection element brought into connection with the detection board 20C. And heat deprived by the Peltier device 31 is radiated from the radiation fin 66 (FIG. 17) via the heat pipe 32 connected to the Peltier device 31. At this time, the heat pipe 32 radiates heat with cool winds introduced into the detector unit in order to cool the analog ASICs on the ASIC board 53B and the digital ASIC (not shown). Incidentally, the cooling mechanism of the detector 21A is not limited to the Peltier device, but the coolant chiller unit, and cooling pipe leading cooling medium from the coolant chiller unit can be used.

Thus, the detector 21A is cooled by way of the detector board 20C in contact with the Peltier device 31. Effects similar to those for the cooling mechanism described with reference to FIGS. 15 and 16 are attainable. In the SPECT apparatus, the packaging density of the detector 21A is important, and it is necessary to make the gap between the detectors 21A each other narrow as much as possible. Accordingly, the present embodiment can realize packaging of detector 21A denser than air cooling requiring cooling space. In addition, heat transfer from the heat-generating integrated circuit to the detector 21A can be limited with the detector board 20C.

Incidentally, the detector 21 with CdTe used in Embodiments 1 and 2 as semiconductor material S reacts to light and generates charge, and thus the housing 30a is configured of material having light shielding/electromagnetic shield properties such as aluminum and aluminum alloy and is arranged not to permit any gap where light enters. That is, the housing 30 is configured to have light shielding properties. Incidentally, in the case where light shielding/electromagnetic shield properties can be secured with other means, the housing 30a is not required to have light shielding properties itself, a frame (frame body) holding the detectors 21 in a detachable/attachable manner will do (for example, plate member (panels) and the like for light shielding is not necessary).

Incidentally, in the embodiments so far, PET apparatus 1 (FIG. 1) and SPFCT (Single Photon Emission Computed Tomography apparatus are described as nuclear medicine imaging apparatus, but without limiting to the PET apparatus and SPECT, the present invention can be applied to a γ camera. Incidentally, the PET apparatus and the SPECT apparatus commonly images three-dimension functional image of a human body, but a SPECT apparatus cannot conduct coincidence detection since principles for measurement are to detect single photon, and thus comprises collimator to control incident position (angle) of a γ-ray. In addition, a γ camera provides functional images obtainable being two-dimensional and comprises collimators to control incident angles of a γ-ray.

Incidentally, configuration may be a nuclear medicine imaging apparatus in which PET apparatus, SPECT apparatus and X-ray CT are brought into combination.

It should be further understood by those skilled in the art that although the foregoing description has been made on embodiments of the invention, the invention is not limited thereto and various changes and modifications may be made without departing from the spirit of the invention and the scope of the appended claims.

1. A nuclear medicine imaging apparatus comprising:
a support member and a plurality of detector units attached to said support member in a detachable/attachable manner,
wherein said detector units include
a housing member, a plurality of semiconductor radiation detectors disposed in said housing member, and an integrated circuit for processing radiation detection signals that said plurality of semiconductor radiation detectors output respectively, and
a cooling apparatus to cool said semiconductor radiation detectors is provided to each of said detector unit.

2. The nuclear medicine imaging apparatus according to claim 1, wherein said cooling apparatus is disposed in said housing member.

3. The nuclear medicine imaging apparatus according to claim 1, wherein said cooling apparatus is configured to form a flow of cooling medium in said housing, and in said housing, said integrated circuits are disposed at a downstream side further than said plurality of radiation detectors in the direction of flow of said cooling medium.

4. The nuclear medicine imaging apparatus according to claim 3, wherein a plurality of unit boards including said plurality of semiconductor radiation detectors and said integrated circuits are disposed in said housing member.

5. A nuclear medicine imaging apparatus comprising:
a support member and a plurality of detector units attached to said support member in a detachable/attachable manner,
wherein said detector units include a housing member and a plurality of unit boards disposed in said housing member,
said unit boards include a plurality of semiconductor radiation detectors to which radiations are incident, and an integrated circuit for processing radiation detection signals that said plurality of semiconductor radiation detectors output respectively, and
a cooling apparatus to cool said semiconductor radiation detectors is provided to each of said detector unit.

6. The nuclear medicine imaging apparatus according to claim 5, wherein said cooling apparatus is disposed in said housing member.

7. The nuclear medicine imaging apparatus according to claim 5, wherein
said unit board includes a board member where said semiconductor radiation detectors are provided, and
said cooling apparatus is provided in said board member so as to cool said semiconductor radiation detectors via said board member.

8. The nuclear medicine imaging apparatus according to claim 7, wherein
said board member includes a heat conductive member.

9. The nuclear medicine imaging apparatus according to claim 6, wherein
said cooling apparatus is a Peltier cooling device.

10. The nuclear medicine imaging apparatus according to claim 6, wherein
another cooling apparatus to cool said integrated circuits is provided in said housing member.

11. The nuclear medicine imaging apparatus according to claim 10, wherein said another cooling apparatus is a cooling apparatus to cool said integrated circuits with cooling medium.

12. The nuclear medicine imaging apparatus according to claim 5, wherein said integrated circuits comprise analog integrated circuits for processing signals that said semiconductor radiation detector outputs, AD converters for converting analog signals being outputs of said analog integrated circuits into digital signals, and a digital integrated circuit for processing signals subject to AD conversion.

13. The nuclear medicine imaging apparatus according to claim 5, comprising a tomographic information creation apparatus for creating tomographic information with second information obtained from first information outputted from said integrated circuits.

14. The nuclear medicine imaging apparatus according to claim 12, wherein said semiconductor radiation detector, said analog integrated circuit, said AD converter and said digital integrated circuit are disposed in said order from one end of said unit board to the other end thereof in the longitudinal direction of said unit board.

15. The nuclear medicine imaging apparatus according to claim 5, wherein
said unit board includes a first board and a second board,
said first board has at least said semiconductor radiation detector, and
said second board has at least said integrated circuits.

16. The nuclear medicine imaging apparatus according to claim 15, wherein said first board and said second board are combined each other in a detachable/attachable manner.

17. The nuclear medicine imaging apparatus according to claim 16, wherein said first board and said second board are combined with respective ends being overlapped each other.

18. The nuclear medicine imaging apparatus according to claim 5, wherein said semiconductor radiation detectors are disposed on both faces of said unit board.

19. The nuclear medicine imaging apparatus according to claim 16, wherein said cooling apparatus is provided to said first board in the vicinity of combined part of said first board and said second board.

20. The nuclear medicine imaging apparatus according to claim 5, wherein
a sealing member for covering said plurality of radiation detectors provided in said unit board is provided to said unit board, and
said cooling apparatus for supplying cooling medium to a space surrounded said sealing member.

21. The nuclear medicine imaging apparatus according to claim 5, wherein said housing member is a heat insulating body.

22. A nuclear medicine imaging apparatus comprising:
a support member and a plurality of detector units attached to said support member in a detachable/attachable manner,
wherein said detector units include a housing member and a plurality of unit boards surrounded by said housing member and disposed in said housing member,
said unit boards include a plurality of semiconductor radiation detectors to which radiations are incident, and an integrated circuit for processing radiation detection signals that said plurality of semiconductor radiation detectors output respectively,
a cooling apparatus is provided to each of said detector unit, and
said cooling apparatus has a cooling device for cooling the cooling medium, and a cooling medium pipe which is connected to said cooling device and has a spout formed in the region in said housing member where said semiconductor radiation detector is disposed so as to spout said cooling medium.

23. The nuclear medicine imaging apparatus according to claim 22, wherein a cooling medium flow path is formed via placement region of said semiconductor radiation detector, and placement region of said integrated circuits to reach the cooling medium outlet of said housing member in said housing member.

24. The nuclear medicine imaging apparatus according to claim 22, wherein said cooling apparatus is disposed in said housing member.

25. The nuclear medicine imaging apparatus according to claim 1, providing a bed where an examinee is loaded and said support member, and having a rotation body to rotate said support member around said bed, wherein:
said semiconductor radiation detectors of said unit boards attached to said support member are disposed at the side of said bed; and
a collimator having a plurality of radiation paths opposing said semiconductor radiation detectors and disposed at the side of said bed further than said semiconductor radiation detectors is disposed at said support member.

26. The nuclear medicine imaging apparatus according to claim 1 or 5, comprising a bed for supporting an examinee, wherein said plurality of detector units are disposed to surround said bed and said semiconductor radiation detectors are disposed at a position closer to said bed than to said integrated circuits in a detector unit.
